(19) United States
(12) Patent Application Publication
(10) Pub. No.: US 2015/0087397 A1
(43) Pub. Date: Mar. 26, 2015

(54) Methods and Systems for Administering Wagering Games Comprising a Plurality of Game Play Election Events

(71) Applicant: Bally Gaming, Inc., Las Vegas, NV (US)

(72) Inventor: Roger M. Snow, Las Vegas, NV (US)

(21) Appl. No.: 14/033,242

(22) Filed: Sep. 20, 2013

(51) Int. Cl. G07F 17/32; A63F 1/00

(52) U.S. Cl. CPC G07F 17/3244; A63F 1/00
USPC 463/25; 273/292

(57) ABSTRACT

A method of administering a wagering game includes accepting an ante wager from a player, dealing cards for a dealer hand, and dealing cards for a player hand. A number of game play elections are administered before the player hand is complete. During each game play election, options are provided to the player, including a play wager option. Acceptance of a play wager during an earlier game play election event does not forestall the acceptance of another play wager during a later game play election event during the same round of play. Acceptance of at least one play wager qualifies the player for a potential play wager payout, otherwise, a fold election is provided as an option during a final game play election event of the game play election events. In some embodiments, at least one of all accepted play wagers is returned should the dealer hand not qualify. Systems for administering wagering games are also disclosed.

### TECHNICAL FIELD

The disclosure relates generally to methods of administering wagering games for casinos and other gaming establishments and to related systems and apparatuses. More specifically, disclosed embodiments relate to methods of, and systems and apparatuses for, administering wagering games including at least one ante wager and at least two opportunities for accepting play wagers.

### BACKGROUND

Many different wagering games presently exist for use in both home and casino environments. Such games should be exciting, uncomplicated, and easy to learn to avoid frustrating players. Poker games, in particular, have gained widespread popularity because of their established ranking of hands and well-known rules. Furthermore, the games usually involve numerous wagering opportunities for the players, thus increasing player participation and excitement. Lastly, the games move fairly quickly to maintain player interest. All of these factors have led to the creation of games that are widely accepted and widely known.

Variations in wagering structures can increase the excitement and acceptance of such wagering games. U.S. Pat. No. 5,417,430 to Breeding discloses a poker game with an altered wagering scheme, thus allowing the player the opportunity to compete for additional and larger prizes or payouts.

Other variations can be made to standard games to allow more player opportunity and involvement. U.S. Pat. No. 5,098,107 to Boylan et al. discloses a game wherein additional game symbols are added to increase wagering opportunities. This allows the player the opportunity to place several wagers on different portions of the game while the game is being played.

Many variations in the play of poker-type games have been introduced to increase the excitement and interest in the play of both table and video versions of poker. Many of the poker variants mentioned above are played against a dealer hand. In more traditional forms of poker, players play against other players, and a highest-ranking hand wins the round. For example, Texas Hold 'Em is a game in which players compete against other players to make a best five-card hand from seven available cards. After the first round of wagering, each player is dealt two cards, face down. Five community cards are later dealt. After viewing the two cards, each player is given the opportunity to make an additional wager. In some embodiments, the additional wager must at least match the opening bet for the round or the player folds. The dealer then reveals the first three community cards (also known in the art as “the flop”). Another round of betting takes place. Then the dealer reveals the fourth community card (also known in the art as “the turn” card) and the last round of betting takes place. The dealer reveals the fifth community card (also known in the art as “the river” card) and compares each player's best five-card hand, made from all seven cards available to the player (i.e., the two player cards plus the five community cards) to determine which player holds the high hand. The high hand wins a pot of wagers received from participating players during the round of play. In some forms of the game, the pot is split so that the player having the second best hand wins 20% of the pot, for example, and the player with the highest hand wins 80% of the pot.

A variation of Texas Hold 'Em is Omaha or Omaha Poker, in which the betting is identical to that in Texas Hold 'Em, but the players initially receive four cards, of which a maximum of two cards may be used in determining the final rank of a five-card poker hand. The game is often played as a “Hi-Lo” game, in which the final pot may be split between the highest hand and the lowest hand, according to poker ranks. A single player may win both a “Hi” hand and a “Lo” hand by declaring and winning both ranking competitions.

U.S. Pat. No. 6,102,402 to Scott describes a community-card-based poker game referred to as a “bad beat stud” game. Each player makes an initial ante wager, and then each player and the dealer receive five cards, face down. The player makes a “first” wager to see a sixth card and a “second” wager to see a seventh card. The sixth and seventh cards are each community cards used by each player and the dealer. Each player's hand is analyzed to see whether the player has a qualifying hand of at least a pair of deuces or better. If the player does not qualify, all wagers are lost by the player. If the player's hand does qualify, all cards of the dealer's hand are turned face up, and each player's hand is compared to the dealer's hand using conventional five-card poker hand rankings to determine whether the player's hand has a higher-ranking poker hand than the dealer's hand. Each player also optionally may make a side bet wager to be eligible for special payouts, including a “bad beat” payout. The special payout can take either of two forms: 1) the player wins preselected payout amounts for poker hand rankings of at least a four-of-a-kind if the player's hand beats or ties the dealer's hand, or 2) the player wins other preselected and much higher amounts for poker hand rankings of at least a straight or higher that the player achieves and that lose to the dealer's hand. Alternatively, the dealer's hand is analyzed to determine whether the dealer has a qualifying hand.

U.S. Pat. No. 6,467,771 to deKeller describes a method for playing a casino game wherein, in a table game format, players make a pot wager and a separate outcome wager. Each player is dealt a plurality of cards, some face up and some face down, and some community cards are additionally dealt. Players are given the option of increasing their outcome wagers and raising the pot during play. The pot is awarded to the player with the highest-ranking hand, and the outcome wager(s) is awarded based upon a schedule of winning outcomes. For an electronic version, the method includes the player making wagers as indicia are revealed and giving the player the opportunity of holding or discarding indicia during play. In certain embodiments, the casino wins at least a portion of the pot based upon either certain community or non-dealt card combinations.

U.S. Pat. Nos. 6,206,373 and 6,637,747 to Garrod describe methods of and apparatus for playing a card game. In one method, the dealer's hand contains a specified card, such as, e.g., the ace of spades, displayed face up. From the remainder of a deck, each player is dealt two face-down cards. After each player views the two face-down cards, each player may act upon his or her hand. The player may be given the option to fold and receive a portion of the original wager back. Alternatively, the player may remain in the game, leaving the original wager unchanged. As a further alternative, the player may be given the option to increase the wager up to a determined amount. After making a decision, five common cards are dealt face up. The common cards are common to each of the players' hands and to the dealer's hand. The dealer is then dealt one card face up to complete the deal. Each player's best five-card hand is compared to the dealer's best five-card hand to determine whether each player is a winner. Additionally, the player may receive a bonus for certain hands. Further, the player may fold and receive a return based on all or some portion of the wager for having one or two of a predetermined card (such as a deuce) in the player's initial two cards.

U.S. Pat. No. 6,517,072 to McInerney describes a playing card wagering game method wherein each player places an initial bet of (i.e., “antes”) one unit. The dealer deals four cards face down to each player and four cards face down to himself. Each player evaluates his or her hand and elects to either fold or challenge the remaining players and dealer. Any player who folds surrenders his or her ante to the house. The total amount of ante bets remaining after each player evaluates his or her hand is referred to as the “ante pot.” All players electing to remain in the game, or to challenge (including the dealer), must wager an amount equal to the ante pot. The dealer always challenges the pot. After each player has elected to either fold or challenge, the dealer, after “burning” (or discarding) an unused card from the deck, will deal or “flop” another three community cards to be used by all challenging participants. The highest poker hand of each participant, using his or her initial four cards plus the three community cards, wins the pot. One player is selected from all of the participating players to be the first player to act, which selection is determined on a rotating basis to eliminate position advantage. In rounds in which a single player plays against the dealer, the player has the option to double the ante pot, resulting in the dealer likewise adding to the ante pot.

U.S. Pat. No. 6,581,936 to Zoccolillo et al. describes a casino card gaming method utilizing a conventional 52-card deck and beginning by first determining the players for a given round. Players may elect to be eligible for receiving a bonus card. The individual players' hands, a set of common cards, and a bonus card for players eligible for the bonus card are dealt. Players that continue through the round determine whether to play the hand as dealt or to utilize the common cards. Players utilizing the common cards discard a number of cards from their hands equal to the number of common cards. The relative ranking of the final hands for the players is determined with the relative ranking based upon the statistical likelihood of obtaining predetermined combinations of cards.

U.S. Pat. No. 6,827,348 to Mitchell describes a playing card wagering game method that involves each player wagering an initial blind bet against the dealer and an optional premium odds side bet for premium-dealt hands having a rank equal to a pair of aces or higher within the first five cards players are dealt, resulting in a payout of six to one. Each of the players and the dealer is dealt five cards in succession face down. Two common cards are dealt face down in succession. The dealer turns the dealer's dealt hand face up to reveal the rank and suit of cards. Players elect to hold on to their dealt hands, for a higher odds payout of two to one, or to place a draw bet equal to their initial bet, to include the use of the two common cards in play to improve their hands, resulting in payouts of even odds for using the first common card and one half odds, i.e., one for two, for using the second common card. The dealer then turns the first and second common cards face up. The dealer always uses the combination of the dealer's dealt hand and both common cards to make the highest ranked poker hand possible. The dealer turns the players' cards face up and declares rank of all hands and resolves all wagers.

There have been casino table wagering games introduced with more flexible wagering structures. As opposed to the more rigid wagering structures of games such as CARIBBEAN STUD® poker (see U.S. Pat. No. 4,836,553) wherein a play wager must be exactly twice an ante wager, FOUR CARD POKER™, and CRAZY 4 POKER™ (as disclosed in U.S. Patent Application Publication No. 2002/0195775, published Dec. 26, 2002, and U.S. Pat. No. 7,387,300, issued Jun. 17, 2008) allow the player to choose among different amounts of play wagers (as compared to the initial ante wager).

One new format of a hold 'em poker-type game provides more cards to the dealer than to the players as described in U.S. Pat. No. 7,140,614, issued Nov. 28, 2006.

### BRIEF SUMMARY

A method of administering a wagering game includes accepting an ante wager from a player. A number of cards is dealt to form a dealer hand, and a group of cards is dealt to form a player hand. A first game play election event is administered, during which a first set of game play election options, comprising accepting a first play wager, is provided. A first election, selected by the player from the first set of game play election options, is accepted. At least one card is dealt to combine with the group of cards for the player hand. A second game play election event is administered, during which a second set of game play election options, comprising a second play wager, is provided. A second election, selected by the player from the second set of game play election options, is accepted. At least one other card is dealt to complete the player hand consisting of the group of cards, the at least one card, and the at least one other card. A third set of game play election options is administered, during which a third set of game play election options, comprising a third play wager, is provided. A third election, selected by the player from the third set of game play election options, is accepted from the player. All accepted wagers are resolved. Acceptance of at least one of the first play wager, the second play wager, and the third play wager is a prerequisite for paying a payout on any of the ante wager, the first play wager, the second play wager, and the third play wager.

In some embodiments, a method of administering a poker-style game comprises accepting an ante wager from a player, dealing cards to form a dealer hand, and dealing other cards to form a player hand. Dealing cards to form the player hand comprises performing a first card distribution act, at least one intermediate card distribution act, and a final card distribution act. After performing the first card distribution act, a first game play election, selected from the group consisting of checking and placing a first play wager limited to a first amount, is accepted from the player. After performing the at least one intermediate card distribution act, a second game play election, selected from the group consisting of checking and placing a second play wager limited to a second amount less than the first amount, is accepted from the player. After performing the final card distribution act, a final group of game play election options is provided. The final group of game play election options is selected from the group consisting of checking, folding and placing a third play wager limited to a third amount less than the second amount. All accepted wagers are resolved.

In other embodiments, a method of administering a wagering game comprises accepting an ante wager from a player and dealing a complete hand of cards to form a dealer hand. Cards are dealt to form a player hand. Dealing the cards to form the player hand comprises performing at least two card distribution acts. A game play election event is administered. In administering the game play election event, a set of game play election options, comprising a play wager option, is provided. An election, selected by the player from the set of game play election options, is accepted from the player. Before performing a last card distribution act of the at least two card distribution acts, at least another game play election event is administered. Administering the at least another game play election event comprises providing another set of game play election options. The another set of play game play election event options comprises another play wager option, and the another set of play wager options is independent of the set of play wager options. Another election, selected by the player from the another set of game play election options, is accepted from the player. After performing the last card distribution act of the at least two card distribution acts, a final game play election event is administered. Administering the final game play election event comprises providing a final set of game play election event options comprising a final play wager option. A final election, selected by the player from the final set of game play election event options, is accepted from the player. All accepted wagers are resolved.

In certain embodiments, a method of administering a wagering game comprises accepting from a player an ante wager and accepting from the player a blind wager equal to the ante wager. Seven cards are dealt to form a seven-card dealer hand. Three cards are dealt for a player hand. A first game play election event is administered, comprising providing a first of game play election event options consisting of checking and a first play wager limited to three times the ante wager. A first election, selected from the first set of game play election event options, is accepted from the player. Two cards are dealt for the player hand. A second game play election event is administered, comprising providing a second set of game play election event options consisting of checking and a second play wager limited to two times the ante wager. A second election, selected from the second set of game play election event options, is accepted from the player. Another two cards are dealt to complete a seven-card player hand. A third game play election event is administered, comprising providing a third set of game play election event options consisting of a third play wager limited to one times the ante wager and one of checking and folding. The one of checking and folding is selected for the third set of game play election event options based on the first election and the second election. A third election, selected from the third set of game play election event options, is accepted from the player. The dealer hand is revealed, and all accepted wagers are resolved based at least in part on at least one of a player hand rank of a five-card player hand derived from the seven-card player hand and a dealer hand rank of a five-card dealer hand derived from the seven-card dealer hand.

Some methods of administering a wagering game include providing a playing device gaming layout displaying a plurality of wagering areas comprising an ante wager area, a blind wager area, and at least three play wager areas. An ante wager at least partially covering the ante wager area is accepted from a player. A blind wager at least partially covering the blind wager area is also accepted from the player. Seven randomly ordered cards are dealt to form a dealer hand. A group of three randomly ordered cards is dealt for a player hand. A first wagering option, selected by the player from a first check election and a first play wager election, is accepted. The first play wager election is limited to an amount of a first integer multiple of the ante wager. The first play wager at least partially covers a first play wager area of the at least three play wager areas. The first check election leaves the first play wager area exposed. Two additional randomly ordered cards are dealt for the player hand. A second wagering option, selected by the player from a second check election and a second play wager election, is accepted. The second play wager election is limited to an amount of a second integer multiple of the ante wager. The second play wager at least partially covers a second play wager area of the at least three play wager areas. The second check election leaves the second play wager area exposed. Another two additional randomly ordered cards are dealt to complete the player hand. A third wagering option, selected by the player from a third play wager election and one of a fold election and a third check election, is accepted. The one of the fold election and the third check election is provided based at least in part on a state of exposure of the first play wager area and the second play wager area. The third play wager election is limited to an amount of a third integer multiple of the ante wager. All wagers at least partially covering one of the plurality of wagering areas are resolved.

Embodiments of the methods described herein may also include returning at least one play wager (e.g., a highest play wager of a plurality of accepted play wagers, an earliest-accepted play wager of a plurality of accepted play wagers) when a dealer hand rank is less than a predetermined qualifying rank. Other accepted wagers, including other accepted play wagers, may then be resolved.

Further embodiments may include one, some, or all of the following: The acts of the dealer may be carried out by a visual representation of a dealer, the visual representation being generated and/or displayed by a computer. The visual representation may be a virtual person (e.g., an animation), or may be a transmission (e.g., a video) of an actual person. The visual representation may be part of an online gaming experience of the disclosed game. The acts described in this disclosure associated with a dealer, including dealing cards, displaying or turning cards over, receiving or paying bets, or any other actions, may be represented in any way when used in an online environment. For example, the cards associated with a dealer action, described as being dealt or otherwise handled by a dealer, may appear as virtual cards or as transmitted pictures of physical cards. This may include a display of virtual card decks where each deck, individual card, and hand is displayed to an online player in a manner consistent with the game play disclosed herein, but may or may not include a visual representation of a dealer with the cards. Likewise, betting activity may be displayed in any manner to a player, including, but not limited to, virtual chips, betting pools, numbers, or other indicia of a bet amount.

The online experience may involve players playing remotely (e.g., in a different physical location) from the dealer, remotely from the location of a game server, or remotely from both, interacting through a networked connection that may include, but is not limited to, the Internet. The online game play may involve players who are also physically remote from each other. Remote connections may use networks involving several types of network links including, but not limited to, the Internet. Networked connections allowing physically remote players to play a game using a game server or system may be part of an implementation of a virtual or online gaming environment.

A system for administering a wagering game over a computer network, according to an embodiment of the present disclosure, comprises an online server-based gaming system configured to be accessed by a user device over a network. The game system includes a processor and associated memory, and is programmed to accept an ante wager instruction from server user device to place an ante wager, communicate to the user device dealer card values forming a dealer hand, communicate to the user device card values for a player hand, accept from the user device a first election from a first set of game play election options comprising a first play wager option, communicate to the user device at least one additional card value for the player hand, accept from the user device a second election from a second set of game play election options comprising a second play wager option, and communicate to the user device at least one final card value for the player hand. The player hand consists of the card values, the at least one additional card value, and the at least one final card value. The gaming system is also programmed to, based at least in part on at least one of the first election and the second election, populate a third set of game play election options with a third play wager election and one of a fold election option and a check election option. The gaming system is also programmed to accept from server user input a third election selected via the client server from the third set of game play election options and resolve all accepted wager instructions.

Live, electronic, or online implementations of the methods described herein may be offered. Implementations may be either “play-for-pay” embodiments or “play-for-fun” embodiments. In play-for-pay embodiments, wagers having real-world monetary value are received and payouts having real-world monetary value may be distributed. Play-for-pay embodiments may include live games played on gaming tables, or “felt games”, games played on computer-controlled gaming platforms, such as table game platforms that utilize physical cards but enable credit wagering, electronic gaming machines, multiple-player gaming machines, lottery-style scratch games and online games. Online games include games in which players make real-money wagers. Other online formats include play-for-fun games, where players are assigned chips of non-monetary value and are awarded chips of non-monetary value. Yet other online formats include play-for-fun games played on social gaming websites. These games enable players to receive a predetermined number of chips per unit of time. If the player wants additional chips, the player can wait until the chips are assigned or purchase a time compression. Regardless of the format, implementations of the games may be player banked or house banked.

Multiple embodiments are processor-controlled embodiments, including gaming machines, multiple player gaming machines and as online games. Online games may include a variety of online embodiments, including house-banked, player pooled progressive, dividend refund, social gaming and play-for-fun embodiments.

In some online embodiments, the game may be reconfigured as a player-pooled progressive pot-style game or as a pot game with a dividend refund mechanic. A gaming establishment may profit from the administration of a pot-type game by, for example, “raking” the wagers (i.e., retaining a portion of the wagers for the house) or charging a seat or room fee in exchange for making the venue available for a predetermined time. In pooled pot embodiments (e.g., “player-pooled progressive” configurations, “dividend refund” configurations), wagers may be raked by the game administrator and then pooled into a pot from which payouts are paid, which pot is eventually distributed to at least one player; thus, the game administrator retains only the raked amounts. Aside from play-for-pay embodiments, play-for-fun embodiments (e.g., “free play-for-fun” configurations, “social play-for-fun” configurations) involve receiving wagers having no real-world monetary value and distributing payouts having no real-world monetary value.

The actions described in this disclosure as the acts of a player, including betting, card selection (if any), card evaluation, card discards (if any), play elections, or any other actions, may be carried out by a processor over a network where the indicated actions are received as input to a device. The input-receiving device is typically physically remote from the game server or game host and is connected over a long-distance network, but may also be implemented over a wired or wireless LAN (local area network) in one building, or even in one room, for example. In one embodiment, game play generated at the server or host location may be displayed on the same device as the receiving device. In some embodiments, game play may be conveyed to remote players in devices separate from the devices receiving input from a player, such as public screens or publicly broadcast data about a game coupled with individual or private input devices. The reception of an input at a device may be accomplished through any technology adapted for such a purpose including, but not limited to, keypads, keyboards, touchpads, touch screens, buttons, mice, optical location devices, eye movement/location detectors, sound input devices, etc. When discussing a device, it is understood the device may comprise multiple components and be complex, including hardware components combined with firmware and/or software, and may itself be a subcomponent of a larger system.

Yet other embodiments may comprise apparatuses and systems for administering wagering games according to embodiments of the disclosure.

### BRIEF DESCRIPTION OF THE DRAWINGS

While the disclosure concludes with claims particularly pointing out and distinctly claiming embodiments within the scope of the disclosure, various features and advantages of embodiments encompassed by the disclosure may be more readily ascertained from the following description when read in conjunction with the accompanying drawings, in which:

FIG. 1 is a flowchart diagram of a method of administering a wagering game, according to an embodiment of the present disclosure;

FIG. 2 is a diagram of a playing surface for implementation of a method of administering a wagering game, according to embodiments of the present disclosure;

FIG. 3 is an enlarged diagram of a player position of the playing surface of FIG. 2, according to an embodiment of the present disclosure;

FIG. 4A is an enlarged diagram of a player position of the playing surface of FIG. 2, according to another embodiment of the present disclosure;

FIG. 4B is an enlarged diagram of a player position of the playing surface of FIG. 2, according to another embodiment of the present disclosure;

FIG. 5 is a flowchart diagram of a method of administering a wagering game, according to a player-pooled progressive embodiment of the present disclosure;

FIG. 6 is a flowchart diagram of a method of administering a wagering game, according to a dividend refund embodiment of the present disclosure;

FIG. 7 is a perspective view of an individual electronic gaming device configured for implementation of embodiments of wagering games in accordance with the present disclosure;

FIG. 8 is a top view of a table configured for implementation of embodiments of wagering games in accordance with the present disclosure;

FIG. 9 is a perspective view of another embodiment of a table configured for implementation of embodiments of wagering games having a virtual dealer in accordance with the present disclosure;

FIG. 10 is a schematic block diagram of a gaming system for implementing embodiments of wagering games in accordance with the present disclosure; and

FIG. 11 is a block diagram of a computer for acting as a gaming system for implementing embodiments of wagering games in accordance with the present disclosure.

### DETAILED DESCRIPTION

Methods of administering wagering games are described, wherein the methods include accepting an ante wager from a player, dealing a group of cards for a player hand, and administering a game play election event during which options, including an additional wager option, are provided to the player. At least one additional card is dealt for the player hand. Another game play election event is administered, during which options, including an additional wager option, are provided to the player. The process of dealing additional cards and administering game play election events may be repeated any number of times. Options provided during more than one of the administered game play election events may be independent of one another. Thus, in administering the methods, more than one wager may be received during the administration of the game play election events.

The illustrations presented herein are not meant to be actual views of any particular act in a method of administering a wagering game, apparatus for use in administering a wagering game, or component thereof, but are merely idealized representations employed to describe illustrative embodiments. Thus, the drawings are not necessarily to scale. Additionally, elements common between figures may retain the same or similar numerical designation. Elements with the same number, but including a different alphabet character as a suffix should be considered as multiple instantiations of substantially similar elements and may be referred generically without an alphabet character suffix. For example, elements 100a, 100b, and 100c, may be a device that is instantiated three times and generically referred to herein as element 100.

The terms “gaming,” “gambling,” or the like, refer to activities, games, sessions, rounds, hands, rolls, operations, and other events related to wagering games, such as web-based games, casino games, card games, dice games, and other games, the outcomes of which are at least partially based on one or more random events (“chance” or “chances”), and on which wagers may be placed by a player. In addition, the words “wager,” “bet,” “bid,” or the like, refer to any type of wager, bet or gaming venture that is placed on random events, whether of monetary or non-monetary value. Points, credits, and other items of value may be purchased, earned, or otherwise issued prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games that involve the risk of real-world monetary value for the potential of payouts with real-world monetary value (e.g., the “play-for-pay” embodiments (e.g., “house-banked,” “player-banked,” and “pooled pot” (e.g., “player-pooled progressive” and “dividend refund”) embodiments), which are described in more detail below) or in wagering games that involve no real-world monetary risks for the player (e.g., the “play-for-fun” and “social play-for-fun” configurations, which are described in more detail below).

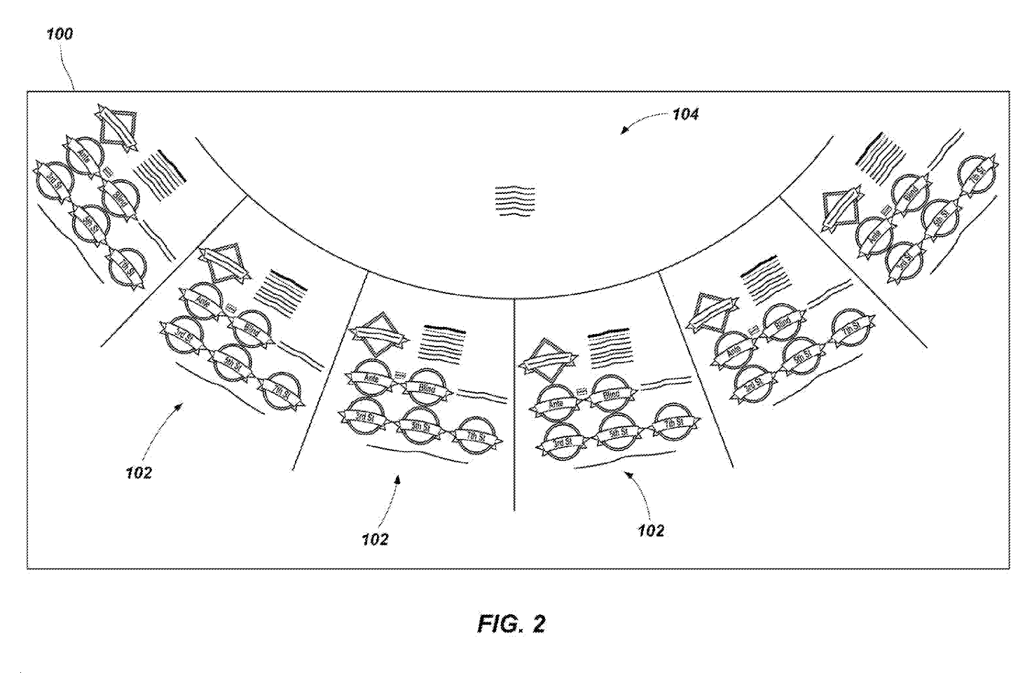

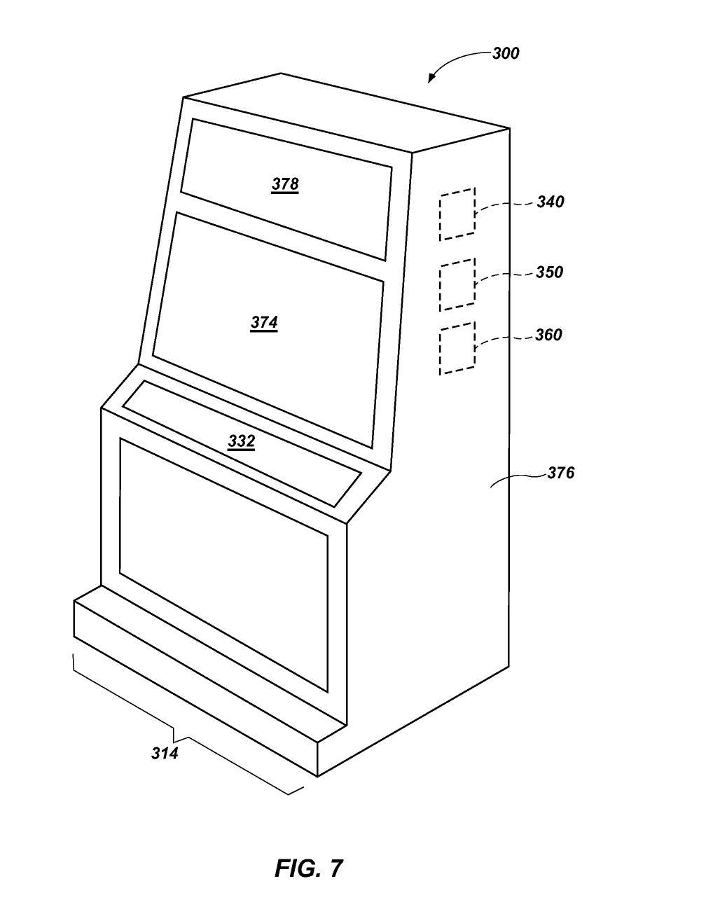

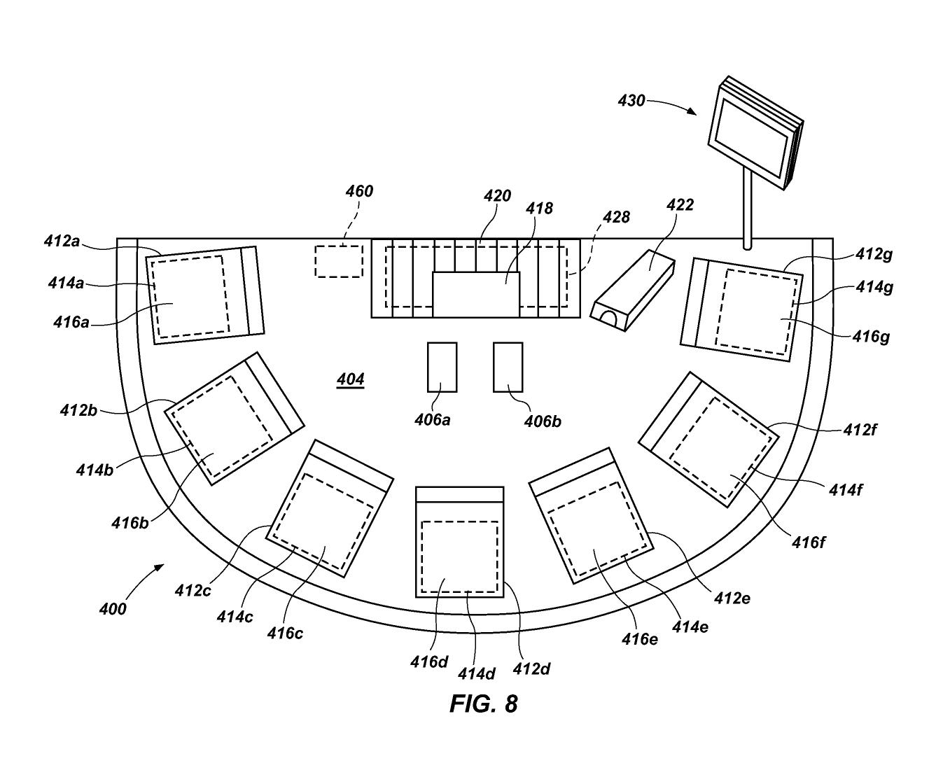

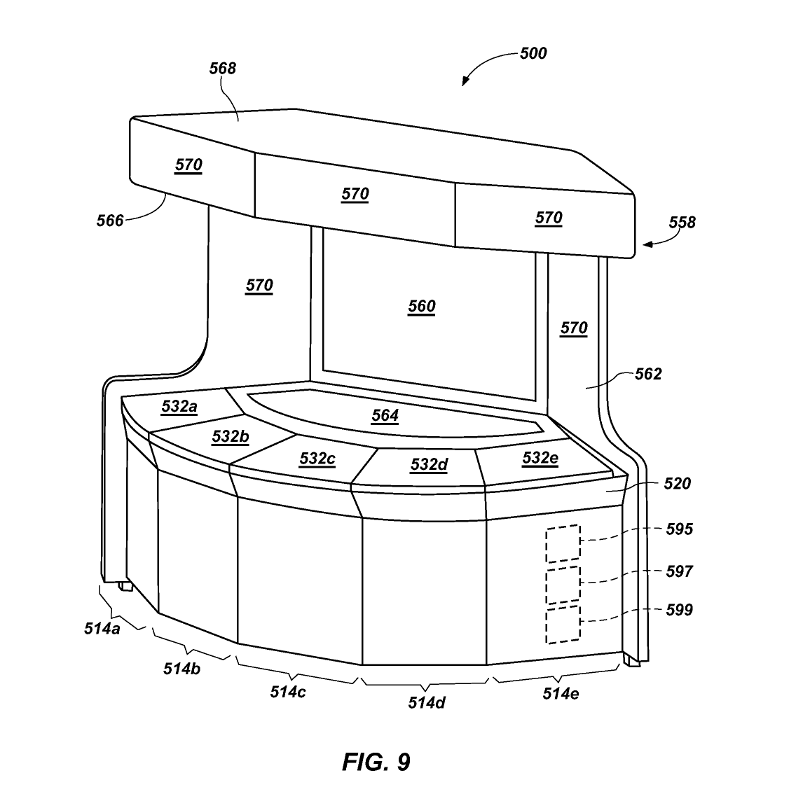

As used herein, the term “wager” includes any form of wagering value, including money, casino chips, other physical means for payment, and online or remote electronic authorization of a wager in any acceptable form to the casino or online or virtual game host. Also included are physical representations of money (e.g., casino chips) at a playing surface 100 (see FIG. 2), a local gaming table 400 or 500 (see FIGS. 8 and 9), or electronic authorizations of a transfer of money or digital representations of money (e.g., digital representations of bills or coins, digital representations of chips, numerical quantities of money, numerical quantities of points, or numerical quantities of credits) at a local or remote electronic gaming device 300, 400, 500, 620, or 640 (see FIGS. 7 through 11). In the “play for fun” and “social play for fun” configurations, a “wager” may not have a cash value (i.e., a real-world monetary value).

For the purposes of this description, it will be understood that when an action related to accepting wagers, making payouts, dealing cards, selecting cards, or other actions associated with a player or a dealer are described, the description includes a player or a dealer taking the action, the results of the action on a live or virtual table or display, and, if applicable, the reception or detection of such an action in an electronic form where player and dealer choices, selections, or other actions are received at an electronic interface. This further includes the results of a virtual dealer and virtual players, where the actions described are actually generated by a computer (typically associated with an online game). By way of a further example, if dealing of a card is described herein, the description includes (but is not limited to): the following: the dealing of a card by a dealer from a deck, shuffler, a shoe or other card source and the reception or placement of the card at a table location associated with a player, or reception directly by a player; the generation and transmission of an electronic indication or representation of a card from a game play source or server to an electronic receiver, where the receiver may be at a table (using virtual cards) including players and/or virtual players and/or a dealer or virtual dealer, at a public display in a casino, at a remote location (e.g., using online or Internet game play), or at other locations. Also included is the representation of a card on a display or displays, and, if applicable to the action described, an electronic reception of an indication that the card has been received, selected, or otherwise interacted with at a location associated with a player, or, associated with a virtual player. In addition, dealing of a card may refer to revealing a representation of a card on a scratch-off card (also referred to as “scratchers”).

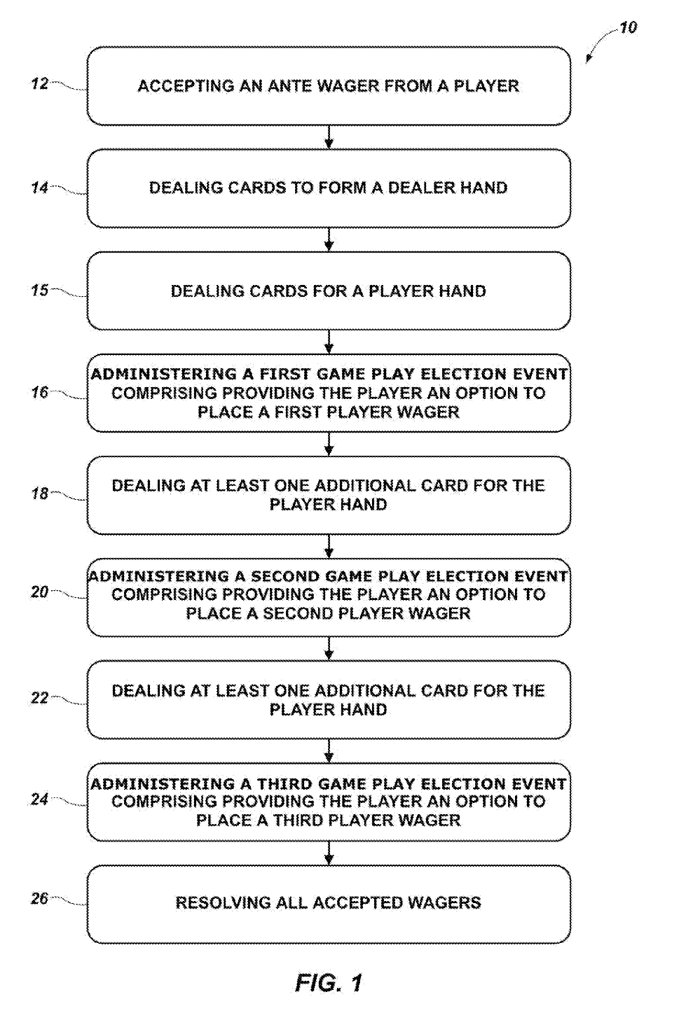

A flowchart diagram 10 of a method of administering a wagering game is illustrated in FIG. 1. The method includes accepting an ante wager from a player (stage 12), dealing cards to form a dealer hand (stage 14), dealing cards for a player hand (stage 15), administering a first game play election event comprising providing the player an option to place a first play wager (stage 16), dealing at least one additional card for the player hand (stage 18), administering a second game play election event comprising providing the player an option to place a second play wager (stage 20), dealing at least one additional card for the player hand (stage 22), administering a third game play election event comprising providing the player an option to place a third play wager (stage 24), and resolving all accepted wagers (stage 26).

With further reference to FIG. 1, administration of the wagering game may begin, as indicated at stage 12, with accepting an ante wager. In some embodiments, a blind wager may also be accepted from the player. The blind wager may be equal in value to the ante wager, or in other embodiments, the blind wager may be unequal in value. In rounds in which the wagering game is administered to more than one player, the ante wager and, depending on the embodiment, the blind wager may be received from each of the participating players. In some embodiments, the ante wager and the blind wager are mandatory (i.e., acceptance of each wager is a prerequisite for the player to participate in play of the wagering game, although there may be additional prerequisites to initiate a player for play in the wagering game or qualify the player for winning the game). In some embodiments, the ante wager and the blind wager are equal in amount, based on predefined limitations.

The ante wager and the blind wager may be received before or after cards are dealt and before or after other wagers are received in the same round. However, the ante wager and the blind wager may be received before cards are revealed to the player. In some embodiments, additional wagers may be received before cards are dealt. In other embodiments, additional wagers may be received before cards are revealed to the player. For example, a side or bonus wager may be accepted before, simultaneously to, or after accepting the ante wager and/or the blind wager. Such side or bonus wagers may be predefined to be resolved by comparing a player's best five-card poker hand of seven cards to a pay table of predetermined winning hand combinations and corresponding payout odds. In examples of the methods of the present disclosure, the player must hold a predetermined winning combination of cards to win the side bet, regardless of the rank or status of the dealer hand.

Cards (e.g., randomly ordered cards from one or more decks of cards) may be dealt to form a dealer hand, as indicated at stage 14. Cards used in the game may be dealt from a standard 52-card deck, such as a deck including a 2, 3, 4, 5, 6, 7, 8, 9, 10, Jack, Queen, King and Ace of each of the heart, diamond, club and spade suits. In other embodiments, cards may be dealt from a standard 52-card deck with one or more wild cards such as 1 or 2 jokers. In some embodiments, cards may be dealt from special decks, such as a deck that has certain cards removed, or from plural decks of intermixed cards, such as a double deck or four decks, for example. Cards may also be dealt for a player hand, as indicated at stage 15. For example, cards dealt for the player hand may be cards designated only for the player hand of one player, not for the dealer hand or any other player hand during the round of the wagering game. Cards dealt to form the dealer hand may similarly be designated only for the dealer hand, not for any other hand during the round of the wagering game. Therefore, in some embodiments, there may be no community cards dealt. In other embodiments, community cards may be used as player cards, dealer cards, or both. Therefore references to player cards and dealer cards can include community cards.

In some embodiments, dealing cards for the dealer hand (stage 14) may form a complete dealer hand. Thus, the dealer's hand may be dealt all cards at once or in succession (e.g., without dealing cards to players between cards dealt for the dealer's hand). In some embodiments, the dealer receives a group of three cards, then a group of four cards and combines the cards to form a hand prior to viewing the faces of the cards. For example, seven cards may be dealt, either at once or in succession, to form a seven-card dealer hand. In some embodiments, the cards of the complete dealer hand may be dealt in a number of card-distribution stages interrupted by other stages of the method. The dealer hand may not be revealed when dealt or immediately thereafter, in some embodiments. The complete dealer hand may be formed before providing the player with another wagering opportunity.

Dealing cards for the player hand (stage 15) may form only a partial player hand. For example, the player may be dealt three cards face down, without revealing the cards to the dealer or to other players. The administrator may provide the player an opportunity to review the initially-dealt partial hand of cards for the player hand. Thereafter, the dealer may administer a first game play election event, indicated at stage 16. Administering the first game play election event includes providing the player with a set of game wager election options from which the player may select a game play election that is then accepted by the administrator. The options include at least a first play wager option. The first play wager may be limited a predefined multiple of the ante wager, a predefined multiple of the blind wager, or some other amount or range of amounts. For example, the first play wager amount may be fixed at three times (3×) the ante wager. In some embodiments, the options provided during the first game play election event also include a “checking” option. Therefore, each player may be provided the option of either placing a first play wager or checking. The administration of the first game play election option may follow dealing a first group of cards for the player hand and may precede revealing any of the cards of the dealer hand. Therefore, the player may select one of the provided options based on knowledge of the partial player hand and without knowledge of cards of the dealer hand. A game play election, selected by the player from the options provided, is accepted. Therefore, at the conclusion of the first game play election option, either a first play wager or a check election is received from the player.

At least one additional card may be dealt for the player hand, as indicated at stage 18. The at least one additional card may be designated for the player hand only, and not for any other player hand or the dealer hand. Therefore, in some embodiments, the at least one additional card is not a community card. In other embodiments, the at least one additional card is a community card. In some embodiments, two additional cards for the player hand are dealt. The additional card or cards may be cards dealt to the player hand, and may be revealed or otherwise reviewable by the player, though, in some embodiments, the additional card or cards may not be revealed to other participating players.

After dealing the additional card(s), the dealer may administer a second game play election event, indicated at stage 20. In administering the second game play election event, a second set of game play event options are provided to the player. The second set of game play event options include at least a second play wager option. The second play wager may be limited to a predefined multiple of the ante wager, a predefined multiple of the blind wager, or some other fixed amount or a range of amounts. In some embodiments, the second play wager amount may be limited to a fixed amount that is less than an amount to which the first play wager was limited. For example, the second play wager may be predefined to be limited to two times (2×) the ante wager in embodiments in which the first play wager is predefined to be limited to three times (3×) the ante wager. In some embodiments, the second set of game play options may also include a checking option.

The second set of game play election event options may be provided independent of the first set of game play election event options and the election accepted from the player from the first set of game play election event options. Thus, in some embodiments, the options providing a player during the second game play election event may be the same options provided regardless of whether the player selected a game play wager option or a checking option during an initial game play election event.

The second game play election event may following dealing the at least one additional card for the player hand (stage 18) and may precede completing the player hand and revealing the dealer hand. Therefore, when the second set of game play election options are provided to the player, the player may have no knowledge of cards of the dealer hand, but may have knowledge of more cards of the player hand than when the first game play election event was administered. Even when the play bet option was received in the first game play election event, the player is permitted to make an additional wager, with additional card information, which provides additional excitement and anticipation for the player. In some embodiments, the second set of game play election options may include a checking election. Thus, the administer provides an opportunity for the player to place another play wager, regardless of whether or not a play wager was accepted during the first game play election event. Therefore, in some embodiments, at the conclusion of administering the second game play election event, a second play wager or a check election is received from the player.

At least one additional card may be dealt for the player hand, as indicated at stage 22. The at least one additional card may be designated for only the player hand, and not for another player hand or the dealer hand. In other embodiments, a community card may be dealt that is used in all player hands, the dealer hand or both. Thus, the at least one addition card may not be a community card. In some embodiments, two additional cards may be dealt exclusively for the player hand, and these cards may complete the player hand. In some embodiments, the complete player hand may be a seven-card player hand. In other examples of the methods of the present disclosure, the hand may be a five-card hand, a four card hand, or a three card hand. The administrator may reveal or otherwise provide the player an opportunity to review the at least one additional card.

After dealing the at least one additional card (stage 22), the dealer may administer a third game play election event, indicated at stage 24. Administering a third game play election event may include providing a third set of game play election event options, at least one of which being a third play wager option. The third play wager may be limited to a predefined multiple of the ante wager, a predefined multiple of the blind wager, or some other fixed amount or range of amounts. In some embodiments, the amount of the third play wager may be fixed at a predefined amount less than the amount to which the second play wager was limited. For example, the third play wager may be limited to an amount equal to the ante wager (i.e., be 1× the ante wager) in embodiments in which the second play wager is limited to an amount equal to two times (2×) the ante wager. In other examples, the third play wager may be more or less than 1× the ante wager, such as 0.5× the ante wager, or 1.5× the ante wager.

It is advantageous for the first, second and third wager amounts to decrease in value as the amount of information provided to the player increases. However, in some embodiments, the second and third wagers may be equal, but less than the first wager. Providing multiple wagering opportunities with increasing player hand information is believed to provide the game with interest and encourages players to continue playing.

The third set of game play election options may also include one or both of a fold election and a checking option. In some embodiments, only one of a fold election and a checking option may be included in the third set of game play election options. The one included may be based at least in part on elections accepted from the player during earlier-administered game play election events, during the same round of the wagering game. For example, in some embodiments, the one member of the third set of game play options, in addition to the third play wager option, may be predefined to be the fold election when no play wager has yet been accepted from the player during previous game play election events. In other embodiments, when two consecutive check options are received in the first and second game play election events, a play wager must be received. Thus, in the final game play election event, a player who has not yet placed a play wager is provided an opportunity to either place a play wager or to fold, but not to check. In such embodiments, the one member of the third set of options, in addition to the third game play election option, may be predefined to be the checking election when a play wager has already been accepted from the player during a previous game play election event. Thus, in the final game play election event, a player who has already placed a play wager is provided an opportunity to either place another play wager or to check.

The third game play election event may be administered after the player hand is complete but before the dealer hand is revealed. Therefore, in some embodiments the player is provided a final play wager opportunity after full knowledge of the player hand but without knowledge of cards of the dealer hand. In other embodiments, additional game play election event opportunities may be provided after partially revealing part or all of the dealer hand or the final play wager opportunity (i.e., the last of the game play election events) may be administered after revealing one or more cards of the dealer hand.

In some embodiments, each of the game play wager amounts may be limited to predefined amount limitations (e.g., fixed multiples of the ante wager). In such embodiments, players may not elect the amount of the play wagers—only whether to place the play wagers. In other embodiments, players may select within a range of multiples, as long as the wagers decrease with increasing player hand information, such as a first wager election of 2× to 3×, a second wager election of 1× to 2× and a third wager election of 0.5× to 1.5×.

In some embodiments, each player's hand and the dealer's hand are complete once each hand has the preselected number of cards (e.g., seven). Each hand may be formed independently, without any community or shared cards. When seven cards are used to form a hand of cards, the players and dealer may arrange a best five-card hand from the available seven cards. In other embodiments, a number of cards equal to a final player and dealer hand can be dealt. In yet other embodiments, the dealer and players may receive unequal numbers of cards, such as a dealer 7-card hand and a player 6-card hand to make a best 5-card hand.

All accepted wagers may then be resolved, as indicated at stage 26. For example, each player hand may be compared with the dealer hand to determine whether each player's wagers win or lose. In some embodiments, each player hand and the dealer hand may have seven cards, and one or more accepted wagers may be resolved based on a comparison of a rank of a best five-card player hand derived from the seven-card player hand to a rank of a best five-card dealer hand derived from the seven-card dealer hand. A poker ranking system may be used. In such embodiments, two cards from each hand may be ignored in comparing hand rankings. In some embodiments, cards not to be used in determining rank may be physically discarded from the hands.

In some embodiments of the wagering game, the dealer hand must qualify with a qualifying rank, such as a pair or better, or with a queen-high or better, otherwise the ante wager, the blind wager, and/or any of the play wagers may be refunded to the player, referred to herein as a “push.” Alternatively, one or more of the wagers may push while another of the wagers may pay an odds payout (e.g., a 1:1 payout based on the amount of the wager). For example, and without limitation, in some embodiments, the highest play wager (i.e., the play wager of the highest value) each player has placed may push if the dealer hand does not qualify. As another example, and without limitation, in some embodiments, the earliest-accepted play wager of all play wagers accepted from a player may push if the dealer hand does not qualify. For example, if the dealer hand rank does not at least equal a rank of a pair, the highest play wager accepted of all play wagers accepted (or the first-received of all play wagers accepted) from a player may be refunded to the player. If more than one play wager was accepted from a player, the other play wagers may be resolved after refunding the highest or earliest-received play wager.

In other embodiments, a side bet wager may have been received, and, upon the occurrence of a dealer not holding a qualifying hand, the payout on the side bet wager, if the player holds a winning side bet hand, is increased (e.g., doubled). In such embodiments, the ante and blind wager are paid 1:1. In yet other embodiments, one or more of the wagers are returned to the player when the dealer hand does not qualify, with a pair, or better, for example.

Resolving all accepted wagers (stage 26) includes resolving all received wagers of the ante wager, the blind wager, the play wager(s), and any side wagers. One or more wagers may be resolved based on a comparison of the player hand rank to the dealer hand rank. Alternatively or additionally, one or more wagers may be resolved based on a comparison of one of the player hand rank and the dealer hand rank to a predefined rank. For example, the ante and play wagers may be resolved based on a comparison of the player hand rank and the dealer hand rank. A winning condition for the ante wager and play wager or wagers may be predefined to be met when the player hand rank exceeds the dealer hand rank. In some embodiments, the winning condition for the ante wager may also include not having accepted a fold election from the player. In such embodiments, then, if the player elects to fold during the final game play election event, the ante wager, the blind wager and all play wagers made are taken and no ante wager payout is available. A push condition for the ante wager, the blind wager and all play wagers made may be predefined to be met when the player hand rank equals the dealer hand rank. In some embodiments, the push condition for the ante wager, blind wager and all play wagers made may also include not having accepted a fold election from the player. A losing condition for the ante wager, blind wager and all play wagers made may be predefined to be met by the dealer hand rank exceeding the player hand rank. In some embodiments, acceptance of the fold election from the player may also be predefined to meet a losing condition. Meeting a winning condition on the ante wager may trigger payment of a payout to the player, such as a 1:1 payout based on the amount of the ante wager and any play wagers made.

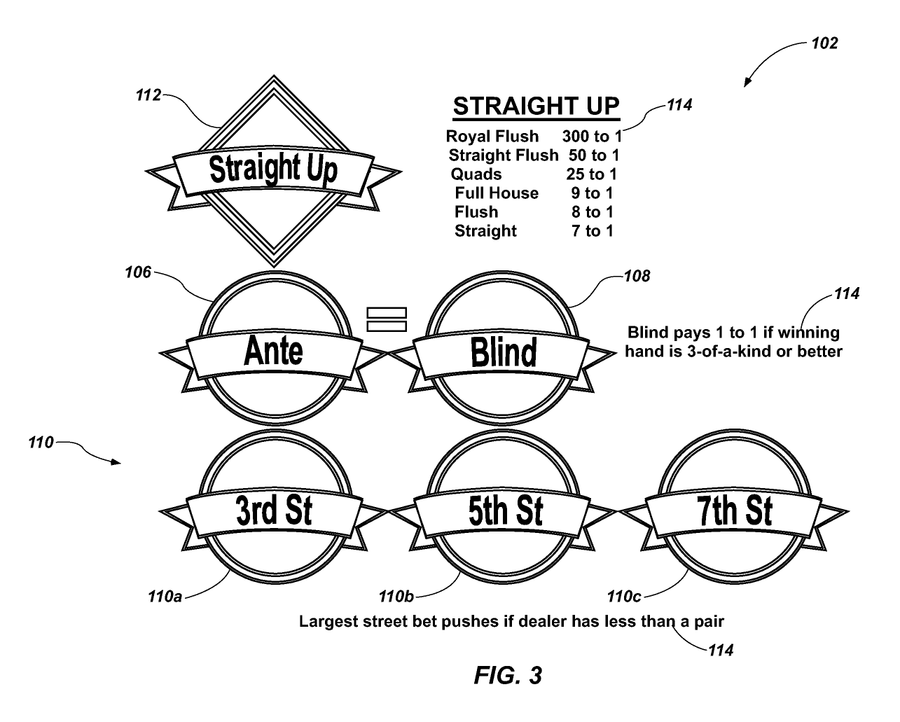

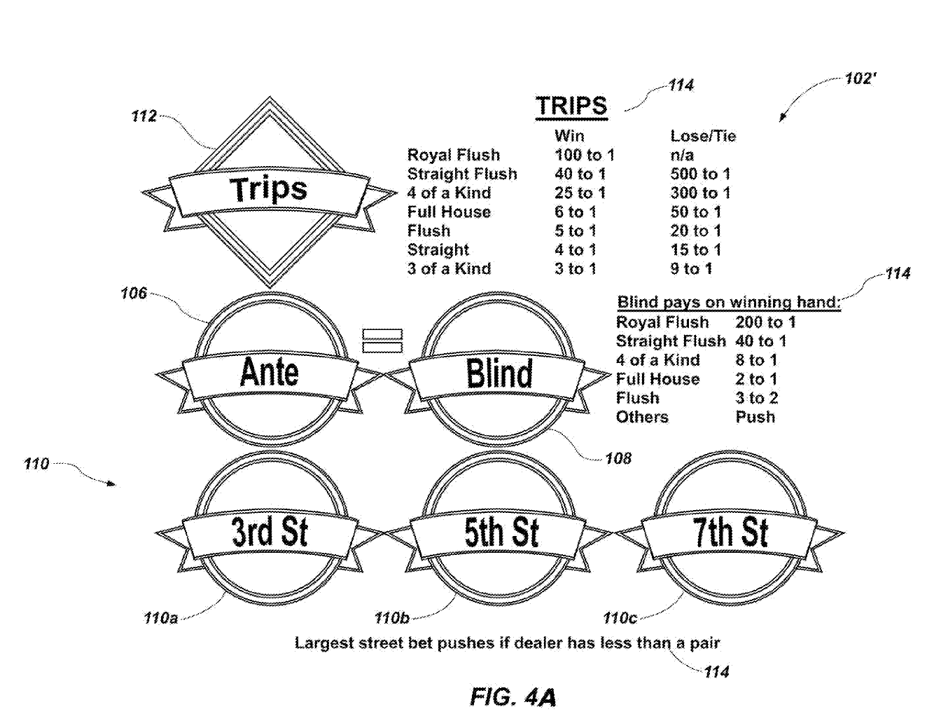

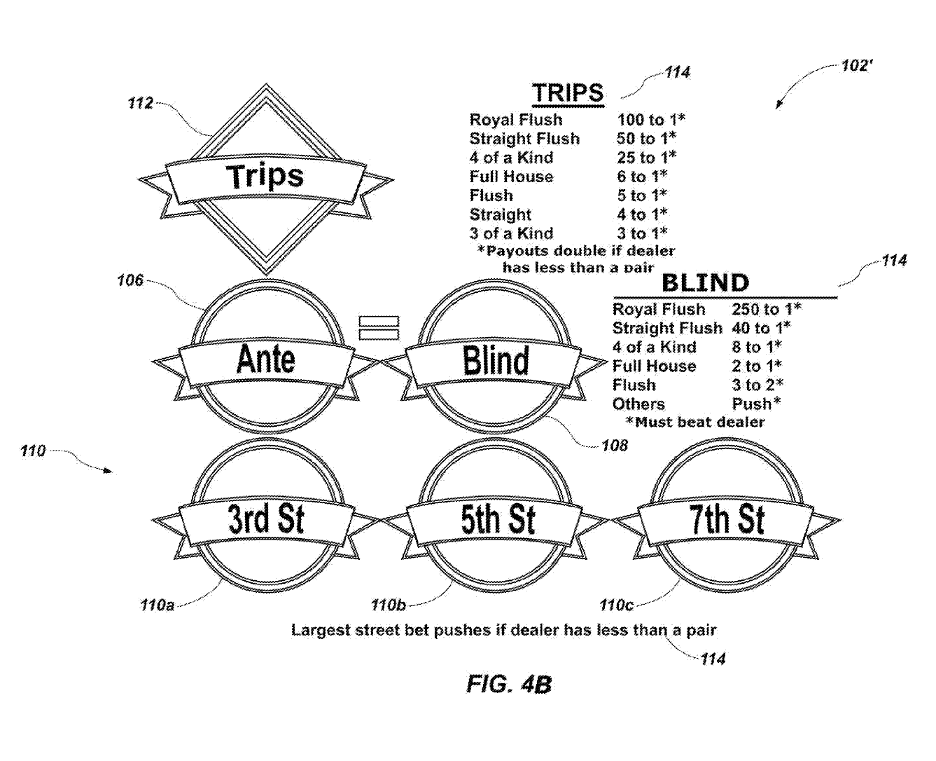

Resolving the blind wager may include a comparison of the player hand rank and the dealer hand rank. A winning condition for the blind wager may be predefined to be met by the player hand rank exceeding both the dealer hand rank and a predefined minimum blind rank (e.g., a three-of-a-kind, a flush) and, in some embodiments, not having received a fold election from the player. A push condition for the blind wager may be predefined to be met by the dealer hand rank equaling the player hand rank or the player hand rank exceeding the dealer hand rank and being exceeded by the predefined minimum blind rank, provided, in some embodiments, the fold election was not received from the player. A losing condition for the blind wager may be predefined to be met by the dealer hand rank exceeding the player hand rank. In some embodiments, acceptance of the fold election may also be predefined to meet a losing condition. Meeting a winning condition on the blind wager may trigger payment of a payout to the player, which payout may be defined by a pay table of at least one odds payout for a corresponding minimum winning hand or better, based at least in part on the player hand rank (e.g., see information area 114 (FIGS. 4A and 4B)) or may be one of plural odds payouts (e.g., a 2:1 payout based on the amount of the blind wager) (see information area 114 (FIG. 3)) for plural predetermined winning hands.

Resolving all accepted wagers (stage 26) also includes resolving all accepted and non-refunded play wagers. In some embodiments of the wagering game, each accepted play wager not refunded due to dealer non-qualification may be resolved similarly. A winning condition for each play wager may be predefined to be met by the player hand rank exceeding the dealer hand rank. In embodiments in which a player is provided an option to fold after placing a play wager, the winning condition may also be predefined to include not receiving the fold election from the player. A push condition for each play wager may be predefined to be met by the player hand rank equaling the dealer hand rank. In some embodiments, as discussed above, another push condition for each play wager may be predefined to be met by the dealer hand rank being exceeded by a predefined minimum qualifying rank. A losing condition for each play wager may be predefined to be met by the dealer hand rank exceeding the player hand rank. Meeting a winning condition on a play wager may trigger payment of a payout (e.g., an even money payout, e.g., a 1:1 payout based on the amount of the play wager) to the player. In other embodiments, the play wagers may pay a different payout, such as 1.5× the play wager or 2× the play wager.

In some embodiments, the method of administering the wagering game may also include accepting a secondary or side wager from the player and resolving the secondary or side wager. The side wager may be accepted before dealing any cards. The side wager may be resolved in accordance with side game rules differing from the rules for the ante, blind, and play wagers. For example, a winning condition for the side wager may predefined to be met by the player hand rank exceeding a predefined minimum rank (e.g., a straight, a three-of-a-kind). A losing condition for the side wager may be predefined to be met by the player hand rank exceeded by the predefined minimum rank. In some embodiments, no push condition may be predefined for the side wager. In some embodiments, acceptance of a fold election from the player may also be a losing condition on any accepted side wager. In other embodiments, the side wager may be resolved regardless of whether a fold election was accepted from the player.

Meeting a winning condition on the side wager may trigger a side payout to the player. The side payout may be defined by a pay table of multiple winning hand combinations and corresponding payout odds. In some embodiments, the pay table may define the side payout based on the player hand rank alone, with the dealer hand rank not impacting the resolution of the side wager (see, e.g., information area 114 under “STRAIGHT UP” in FIG. 3).

In other embodiments, the pay table for the side wager may define the side payout based on the player hand rank and a comparison of the player hand rank to the dealer hand rank. For example, more than one side pay table may be provided, with one side pay table defining side payouts for the player hand rank at least equaling the predefined minimum rank (e.g., a three-of-a-kind) and the player hand rank equaling or falling below the dealer hand rank (see, e.g., information area 114 under “TRIPS” and “Lose/Tie” in FIG. 4A) with another side pay table defining side payouts for the player hand rank at least equaling the predefined minimum rank (e.g., a three-of-a-kind) and exceeding the dealer hand rank (see, e.g., the information area 114 under “TRIPS” and “Win” in FIG. 4A). The former side pay table, i.e., the “Lose/Tie” pay table, may define higher odds payouts than the latter side pay table, i.e., the “Win” pay table. Example “Lose/Tie” and “Win” pay tables are shown below as Table 1a. Thus, when a high-ranking player hand loses to an even higher dealer hand rank, the side wager may be resolved by paying a higher payout to the player, based on, e.g., the player hand rank beaten, than the side payout that would be paid had the high-ranking player hand beaten a lower-ranking dealer hand rank. In other embodiments, the side payout may be a fixed odds-based payout (e.g., a 1:1, a 2:1) payout based on the amount of the side wager.

TABLE 1a
Sample side wager payouts

| Player Hand Rank | Win | Lose/Tie |
|---|---|---|
| Royal flush | 100:1 | n/a |
| Straight flush | 40:1 | 500:1 |
| Four-of-a-kind | 25:1 | 300:1 |
| Full house | 6:1 | 50:1 |
| Flush | 5:1 | 20:1 |
| Straight | 4:1 | 15:1 |
| Three-of-a-kind | 3:1 | 9:1 |

As one nonlimiting example, in one embodiment, both the first pay table (the Win pay table) and the second pay table (the Lose/Tie pay table) may define a predetermined minimum rank of a three-of-a-kind. When a player hand rank equals a three-of-a-kind and beats a dealer hand rank of two pair, the first pay table (the Win pay table) may be applied to define a side payout of three times the side wager (i.e., a 3:1 payout). However, when a player hand rank of a three-of-a-kind loses to a dealer hand rank of a four-of-a-kind, the second pay table (the Lose/Tie pay table) may be applied to define a side payout of nine times the side wager (i.e., a 9:1 payout). Such a payment definition structure may allow players more variety in winning opportunities, thus keeping players engaged and increasing the excitement of the game. The higher payouts under the “Lose/Tie” pay table may also increase player satisfaction with a high side wager payout, compensating for a disappointment in losses on other wagers during the round of the wagering game.

In other embodiments, the pay table for the side wager may define the side payout based on the player hand rank and whether the dealer hand rank at least equals a qualifying rank (e.g., a rank of a pair), which, in some such embodiments, may be the same qualifying rank used to resolve another wager (e.g., a largest accepted play wager) in the same round of the wagering game. For example, a side pay table may be provided defining side payouts for the player hand rank at least equaling the predetermined minimum rank (e.g., a three-of-a-kind), provided the dealer hand rank at least equals a qualifying rank (e.g., a pair) and regardless of how the player hand rank compares to the dealer hand rank (see, e.g., information area 114 under “TRIPS” in FIG. 4B). The pay table may define a higher side payout for the player hand rank at least equaling the predetermined minimum rank (e.g., a three-of-a-kind) and the dealer hand rank being exceeded by the qualifying rank (e.g., a pair), also regardless of how the player hand rank compares to the dealer hand rank. For example, when the dealer hand does not qualify, the pay table may define a side wager payout that is double that of the side wager payout defined by the pay table when the dealer hand does qualify. An example pay table, according to such an embodiment, is shown below as Table 1b.

TABLE 1b
Sample side wager payouts

| Player Hand Rank | Odds Payout |
|---|---|
| Royal flush | 100:1* |
| Straight flush | 50:1* |
| Four-of-a-kind | 25:1* |
| Full house | 6:1* |
| Flush | 5:1* |
| Straight | 4:1* |
| Three-of-a-kind | 3:1* |

*Payout double if dealer has less than a pair

As one nonlimiting example, in one embodiment, the side wager pay table may define a predetermined minimum rank of a three-of-a-kind and a qualifying rank for the dealer hand of a pair. When a player hand rank equals a three-of-a-kind, regardless of whether the player hand rank beats the dealer hand rank, and the dealer hand rank at least equals a pair, the pay table (e.g., Table 1b) may be applied to define a side payout of three times the side wager (i.e., a 3:1 payout). However, when the player hand rank equals a three-of-a-kind, regardless of whether the player hand rank beats the dealer hand rank, and the dealer hand rank falls below the rank of a pair, the pay table (e.g., Table 1b) may be applied to define a side payout of six times the side wager (i.e., a 6:1 payout). Such a payment definition structure may allow players more variety in winning opportunities, thus keeping players engaged and increasing the excitement of the game. The higher payouts when a dealer does not qualify may also increase player satisfaction in a round in which a player has a high-ranking player hand but has had a large play wager push due to dealer non-qualification, compensating for a disappointment in a missed win opportunity on the large play wager during the round of the wagering game.

In other embodiments, side wagers may alternatively or additionally include a wager for which a winning condition triggers a progressive payout from a pot that may accumulate between rounds of the wagering game.

Various platforms are contemplated that are suitable for implementation of embodiments of wagering games according to the present disclosure. For example, embodiments of wagering games may be implemented such that wagers may be received from one or more players, and game play may be administered with the one or more players according to the rules of the wagering games. For example, wagering games may be implemented on gaming tables, which may include physical gaming features, such as physical cards and physical chips, and may include a live dealer and a shuffler or shoe. More specifically, a live dealer may deal physical cards, evaluate hands, accept wagers, accept player elections, issue payouts, and perform other administrative functions of game play. Some embodiments may be implemented on electronic devices enabling electronic gaming features, such as providing electronic displays for display of virtual cards, virtual chips, game instructions, pay tables, etc. Some embodiments may include features that are a combination of physical and electronic features.

As an example, embodiments of wagering games may be implemented on an individual gaming device such as a video poker machine configured to accept wagers and having a display screen and input devices for enabling game play of the wagering games. Such an individual gaming device may be linked with other gaming devices that may be operated, for example, by other players. Some individual electronic gaming devices may be referred to as an individual player “electronic gaming machine” and may be stationary, such as being located on a casino floor. Other individual electronic gaming devices may be portable devices that may be carried to different locations by the player. Portable devices may include both display of the ongoing game play and input reception for game play by a player. Portable devices may, alternatively or additionally, be configured for receiving input from a player while the game play is displayed on a public monitor or other display device. Game play and game outcomes may also be displayed on a portable device.

As previously noted, any of the present methods and games may be played as a live casino table card game, as a hybrid casino table card game (with virtual cards or virtual chips), on a multi-player electronic platform (as disclosed in U.S. Pat. No. 7,661,676, issued Feb. 16, 2010 and U.S. Pat. No. 8,272,958, issued Sep. 25, 2012, each filed on Jan. 26, 2004, the disclosure of each of which is incorporated herein in its entirety by this reference), on a personal computer for practice, on a hand-held game for practice, or on a legally authorized site on the Internet.

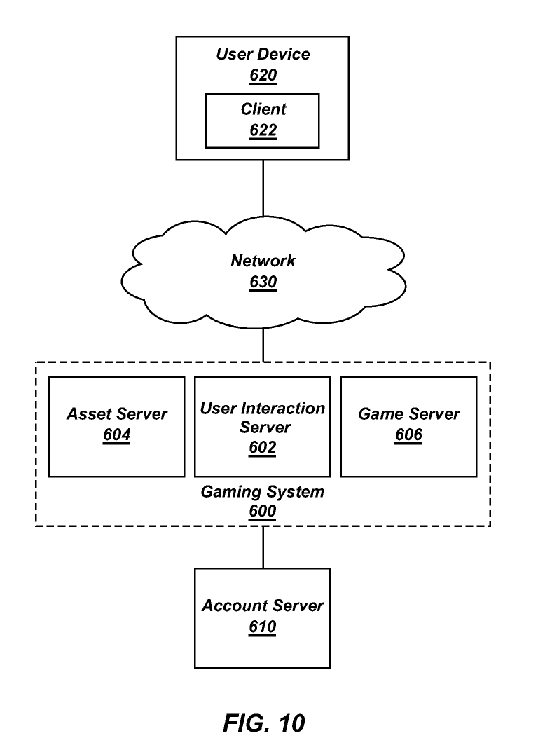

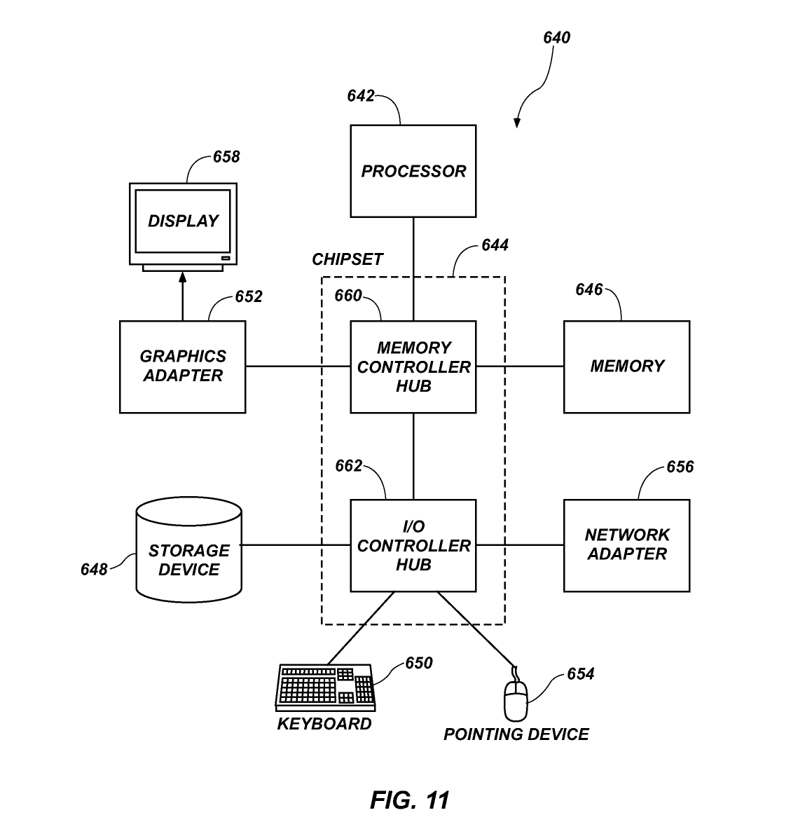

For example, in one embodiment, the players may be remotely located from a live dealer, and a live dealer and a game table may be displayed to players on their monitors via a live video feed. The players' video feeds may or may not be transmitted to the dealer and may also be shared among the players at the table. In a sample embodiment, a central station may include a plurality of betting-type game devices such as a gaming table with a felt covering and an electronic camera for each game device. A plurality of player stations, remotely located with respect to the central station, may each include a monitor, for displaying a selected game device at the central station, and input means, for selecting a game device and for placing a bet by a player at the player's station relating to an action involving an element of chance to occur at the selected game device. Further details on gambling systems and methods for remotely located players are disclosed in U.S. Pat. No. 6,755,741, issued Jun. 29, 2004, titled “Gambling Game System and Method for Remotely-Located Players,” the disclosure of which is incorporated herein in its entirety by this reference, and in connection with FIGS. 10 and 11.

Referring to FIG. 2, shown is a diagram of a playing surface 100 for implementation of the wagering games within the scope of the present disclosure. Embodiments of methods for administering wagering games may be carried out using a wagering game table having a playing surface 100 (also referred to herein as a “layout”). The playing surface 100 may include multiple player areas 102, (e.g., six player areas 102). The playing surface 100 may also include a dealer area 104 (also referred to herein as a “dealer position”).

Referring to FIG. 3, illustrated is an enlarged diagram of one of the player areas 102 of the playing surface 100 of FIG. 2, wherein the player area 102 is configured for implementation of an embodiment according to the present disclosure. In administering a round of the wagering game, a mandatory ante wager, placed on an ante wager area 106 and at least partially covering the ante wager area 106, may be accepted from a player. A mandatory blind wager, placed at least partially on a blind wager area 108, may be accepted from the player. The mandatory blind wager may be required to be equal to the ante wager. Each player area 102 may include a plurality of play wager areas 110, such as two or three play wager areas 110. These play wager areas may bear familiar poker-style names such as 3^{rd} Street, 5^{th} Street and 7^{th} Street names. At various points during play, players may place play wagers, placed on different play wager areas 110 as determined by the rules of the game. In some embodiments, players may indicate wagers by other means, such as by means of a user input, such as a keypad or touchscreen controls. A signal indicating a user input is generated by a user pressing a button or clicking an option on a computer. The computer may then place (e.g., by graphic illustration) a graphical representation of a wager at least partially over the play wager areas 110. When a wager is not placed by a player (e.g., when a player checks), the wager area for that wager remains exposed. For example, in a game in which seven cards are dealt in a pattern of three cards, followed by two cards, followed by two more cards, wagers may be received from the players on the play wager area 110a (marked, for example, “3^{rd} St”) after the first three cards are dealt. Wagers may be received on the play wager area 110b (marked, for example, “5^{th} St”) after the first group of two cards are dealt. Wagers may be received on the play wager area 110c (marked, for example, “7^{th} St”) after the second group of two cards are dealt. Each player area 102 may also include a side wager area 112, on which players may place optional side wagers. For example, optional side wagers may be received before cards are dealt, such as concurrently with the placement of ante and blind wagers. Each player area 102 may optionally include one or more information areas 114. The information areas 114 may include wager payouts (e.g., payout tables), abbreviated rules, or other predefined information provided by the administrator to the player.

As shown in FIG. 3, the ante wager area 106, the blind wager area 108, the play wager areas 110, and the side wager area 112 may be organized in distinct groupings. For example, the side wager area 112 may be proximate to the dealer position 104 (FIG. 2), the play wager areas 110 may be proximate to the player's position, with the ante wager area 106 and the blind wager area 108 between the side wager area 112 and the play wager areas 110. As shown in FIG. 3, the side wager area 112 may be in a top row (i.e., farthest from the player), the ante wager area 106 and the blind wager area 108 may be in a middle row, and the play wager areas 110 may be in a bottom row. Some of the wager areas may be defined by different shapes. For example, the side wager area 112 may be of a different shape (e.g., a diamond) than the shape of the ante wager area 106 and blind wager area 108 (e.g., circles) and, in some embodiments, different than the shape of the play wager areas 110 (e.g., circles). Each of the wager areas may bear text corresponding to one wager of the various acceptable wagers. Thus, each wager area is visually distinguished from other wager areas and visually designates each wager area for only one of the various acceptable wagers. Thus, acceptance of a wager on one wager area designates the wager to be resolved based on the winning, losing, and/or push conditions predefined as associated with the wager area. Payouts on wagers so received may be delivered proximate to the associated wager area.

FIGS. 4A and 4B show an enlarged diagrams of other embodiments of a player area 102′ of the playing surface 100 of FIG. 2. The player areas 102′ of FIGS. 4A and 4B differ from the player area 102 of FIG. 3 in that different information is included in the information areas 114. For example, the information areas 114 shown in FIGS. 4A and 4B illustrate different pay tables and other rules than the information areas 114 shown in FIG. 3. The playing surface 100 (FIG. 2) may be provided to have the appropriate information for the particular game to be played, such as different pay tables, different wager names, different qualifying conditions, etc.

In some embodiments, the wagering games administered with either the player area 102′ of FIG. 4A or FIG. 4B may be administered in similar manner to the games administered with the player area 102 shown in FIG. 3. However, the rules for payout of certain wagers and qualifying conditions may differ. For example, as shown in the information area 114 next to the blind wager area 108 in FIG. 4A, the dealer may resolve the blind wager based on a pay table of predetermined winning hand combinations and corresponding payout odds.

In certain embodiments, there may be at least two pay tables defining payouts for resolution of the side wager—one pay table may define payouts for the player hand rank exceeding the dealer hand rank (i.e., a “Win” pay table), and another pay table may define payouts for the player hand rank equaling or being exceeded by the dealer hand rank (i.e., a “Loss/Tie” pay table). The dealer may thus pay one or more side payouts even to a player having a lower-ranked hand than the dealer hand. In other embodiments, the dealer may pay a player a fixed multiple (e.g., 1:1) of the side wager when the player's hand is of a preselected rank or higher. For example, the dealer may pay the player 1:1 on the side wager when that player has three-of-a-kind or better. In other embodiments, the dealer may pay the side wager only when the player's hand beats the dealer's hand.

In some embodiments, the wagering games described herein may be played against the game administrator, i.e., “the house” (i.e., be “house-banked”), which may involve the game administrator (e.g., a casino or other gaming establishment) receiving (via a dealer who may be employed by the administrator) wagers having real-world monetary value, comparing a player hand against a dealer hand, distributing payouts having real-world monetary value to winning players, and retaining lost wagers. For example, losses on the ante wager, the blind wager, any of the play wagers, and the side wager may be retained by the house, while payouts on the ante wager, the blind wager, any of the play wagers, and the side wager may be paid by the house. Such “house-banked” embodiments may be implemented in the form of a live table game, in a virtual table game, in an electronic game, or in an online game configuration (e.g., over a network).

Accordingly, disclosed is a system for administering a wagering game over a computer network, which wagering game may be house-banked in some embodiments. The system comprises an online server-based gaming machine configured to be accessed by a user device over a network, the gaming system comprising a processor and associated memory. The processor is programmed to accept an ante wager instruction from a user device to place an ante wager, communicate to a user device dealer card values forming a dealer hand, communicate to a user device card values for a player hand, accept from a user device a first election selected from a first set of game play election options comprising a first play wager option, communicate to a user device at least one additional card value for the player hand, accept from a user device a second election selected from a second set of game play election options comprising a second play wager option, and communicate to a user device at least one final card value for the player hand. The player hand consists of the card values, the at least one additional card value, and the at least one final card value. The online gaming machine is also programmed to, based at least in part on at least one of the first election and the second election, to populate a third set of game play election options with a third game play wager option and one of a fold election and a check election option. The gaming machine is also programmed to accept from a user device a third game play election option, selected from the third set of game play election options, and to resolve all accepted wager instructions.

In other embodiments, the wagering games, or at least one wager associated with the wagering game, may involve a player acting as a banker, accepting wagers having real-world monetary value, issuing payouts having real-world monetary value, and retaining lost wagers (i.e., be “player-banked”). More specifically, player-banked games may be administered live in a casino or other gaming establishment such as a card room utilizing physical cards and betting chips. The player or a professional banker retains wagers lost by the players, and pays winning bets, and the casino or other gaming establishment may collect a player entrance fee or a rake on each wager from the participating players, including the banker. For example, a gaming establishment may provide a gaming layout, e.g., on a physical gaming table, and a dealer, and may host a least one participant during the administration of the game. At least one of the participants may be designated as the banker. In some embodiments, a separate dealer, who may be provided by the gaming establishment, may administer the game, with the participant designated as the banker being responsible for funding all payouts paid and profiting from all losses retained during the round of the wagering game. The gaming establishment may collect a commission (e.g., an entrance fee or rake) from all participants, including the designated banker, and/or from wagers accepted during the administration of the wagering game.

In some embodiments, such as online wagering websites that only host “poker” and not house-banked card games, may administer games as “player pooled” embodiments. In player pooled embodiments, wagers (less a rake) are placed in a pot and losses on wagers are collected into the pot and eventually distributed to one or more players. Such pooled pot embodiments may include a player-pooled progressive embodiment, in which a pot is eventually distributed when a predetermined progressive-winning hand combination or composition is dealt. Pooled pot embodiments may also include a dividend refund embodiment, in which at least a portion of the pot is eventually distributed in the form of a refund distributed, e.g., pro-rata, to the players who contributed to the pot.

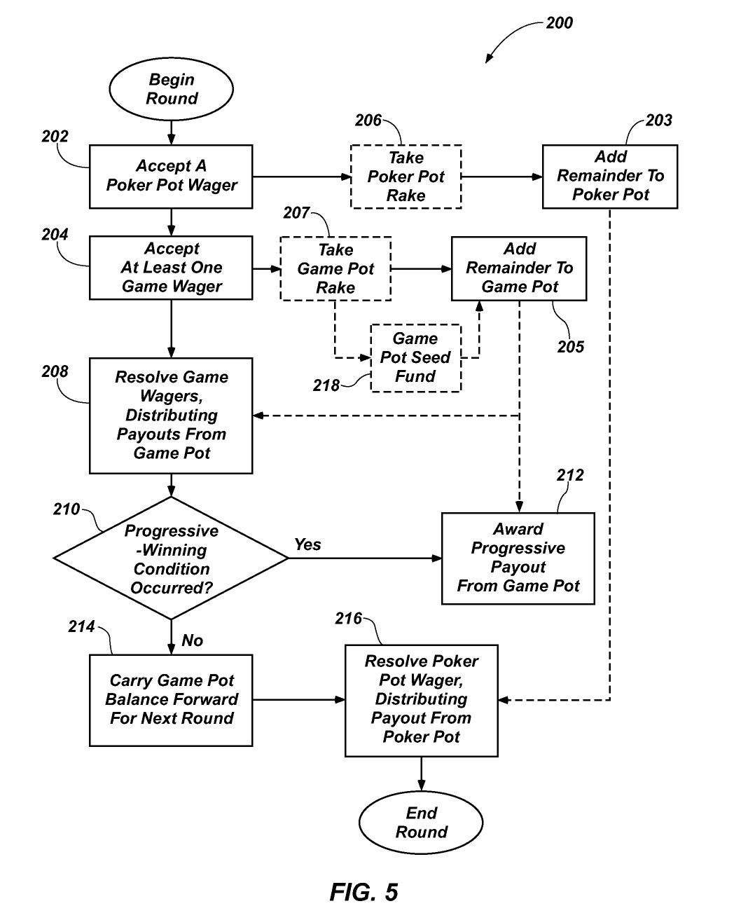

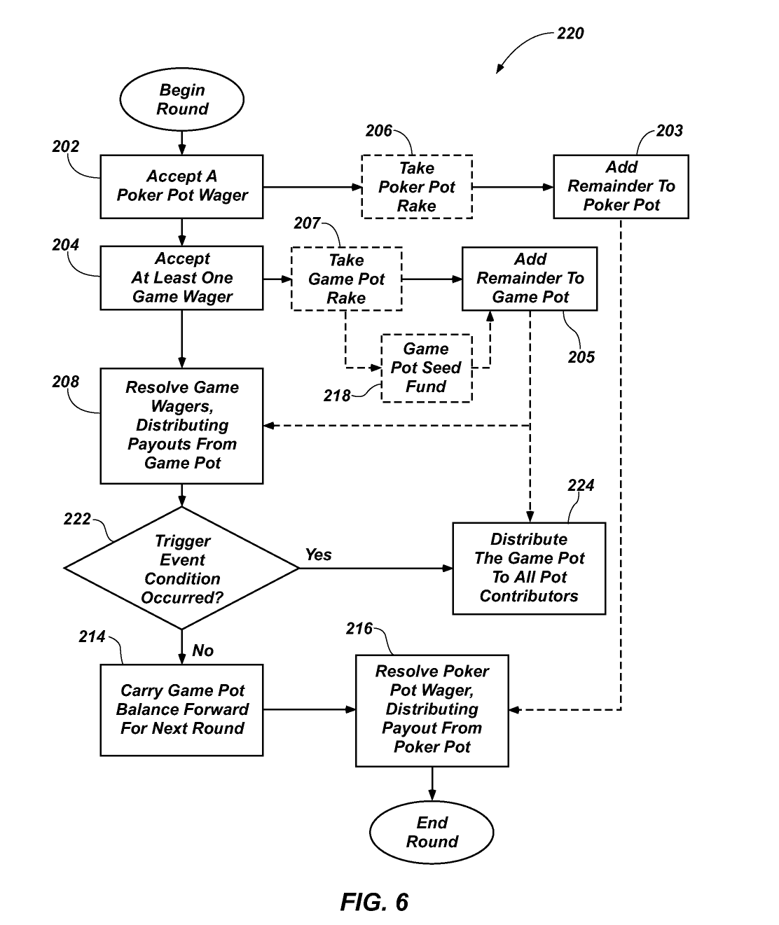

In some pooled pot embodiments, due to regulatory constraints, the game administrator may not obtain profits from chance-based events, occurring in the wagering games, and resulting in lost wagers. Instead, lost wagers may be redistributed back to at least one player, which may enable the wagering games to qualify as nonbanked games under Class II of the Indian Gaming Regulatory Act or other gaming regulations. Accordingly, the wagering games may, in some jurisdictions, be offered over the Internet, or another network, as an online poker wagering game. To profit from the wagering game, the game administrator may retain a commission, such as, for example, a player entrance fee or a rake taken on wagers, or alternatively on payouts, such that the amount obtained by the game administrator in exchange for hosting the wagering game is limited to a commission and is not based on the chance events occurring in the wagering game itself. Specific, illustrated mechanisms for redistributing the lost wagers back to players are described in connection with FIGS. 5 and 6.

Referring to FIG. 5, shown is a flowchart diagram of a method 200 of administering a wagering game, which may be a pooled pot embodiment, such as a player-pooled progressive embodiment. The method 200 includes accepting a first mandatory wager, referred to herein as a “poker pot wager,” as indicated at operation 202. This wager is in addition to all wagers illustrated in FIGS. 3, 4A, and 4B, for example. At least a portion of the poker pot wager is added to a poker pot, as indicated at operation 203. The poker pot wager may be resolved by comparing player hands and awarding the poker pot to the player or players associated with the best hand according to the rules, such as the best five-card poker hand of all participating player hands at the conclusion of a round of the wagering game. For example, a player holding, e.g., a five-card royal flush that outranks the player hands of all other participating players may be awarded the poker pot in a player-pooled progressive embodiment.

The poker pot may be a non-progressive pot in that all or substantially all of the poker pot may be distributed at the conclusion of each round of administration of the wagering game. In some embodiments, the poker pot wager may be a mandatory wager to qualify the player for play of the underlying wagering game. In other embodiments, the poker pot wager may be optional, and the wagering game may be administered with a player without receiving the poker pot wager and without qualifying the player for a potential payout from the poker pot.

The dealer may also accept at least one game wager as indicated at operation 204. The game wagers may include, for example, a base game wager (e.g., ante wagers, blind wagers, play wagers, raises, and other wagers made on the underlying wagering game) and/or a side wager. The at least one game wager may be accepted, for example, by performing any of the acts described previously in connection with FIG. 1. At least a portion of the at least one game wager is added to a separate game pot, as indicated at operation 205, which may be a progressive pot. This pot amount will generally grow over a jackpot cycle, but will fall in value as payouts are made on the base game, regardless of whether the game wagers are mandatory or optional. It is therefore advantageous to electronically track the value of the game pot, and display the amounts as they change in real-time.

Optionally, a third pot wager may be accepted and added to at least a third pot. The third pot may be separate from either or both of the poker pot and the game pot. For example, the poker pot, the game pot, and the third pot may include chips located in separate areas on a gaming table when the wagering game is conducted live in a casino. As another example, the poker pot, the game pot, and the third pot may be displayed as separate amounts on one or more video displays 374, 404, 414, 418, 430, 532, 560, 564, and 658 (see FIGS. 7, 8, 9, and 11) (e.g., a monitor) controlled by one or more of processors 350, 414, 428, 597, and 642 (see FIGS. 7, 8, 9, and 11) and may be maintained in separate accounts when the wagering game is conducted online or in another electronic format.

In some embodiments, acceptance of the at least one game wager qualifies a player to be eligible to win an award, in addition to the payouts available from the underlying game (i.e., the ante, blind, play, and side wagers) such as, for example, a progressive payout (e.g., a progressive jackpot awarded to one or more qualifying players). Therefore, in such embodiments, a progressive wager may be received, as one of the at least one game wagers, in addition to the other game wagers received from the player, such as the ante, blind, play, and side wagers. In some embodiments, the progressive wager may be a mandatory wager to qualify the player for play of the underlying wagering game. In other embodiments, the progressive wager may be optional, and the wagering game may be administered with a player without receiving the progressive wager, in addition to the other game wagers, from the player and without qualifying the player to be eligible to win the progressive payout from the game pot.

In some embodiments, the poker pot wager and the at least one game wager may be received as indistinct wagers, with a portion thereof being designated for the poker pot (a non-progressive pot) and another portion being designated for the game pot (a progressive pot). The poker pot wager and the at least one game wager (including the progressive wager, depending on the embodiment) may be accepted, for example, by performing any of the acts for accepting wagers, described previously in connection with FIG. 1.

In some embodiments, the game pot may be a pooled or linked pot. For example, the game pot may include one or more game wagers accepted from multiple concurrent wagering games. As another example, the game pot may include pooled progressive wagers from those wagering games currently being played and/or may include accumulated game wagers from past wagering games. As specific, nonlimiting examples, the game pot may include all game wagers accepted from a group of tables (e.g., a group of electronic gaming tables) or other local wagering game administration devices at a casino, from multiple groups of remote devices connected to network gaming architecture, or both. In other embodiments, the game pot may not be pooled, and awards for the game wager may be limited to the amounts wagered at a respective table (e.g., electronic gaming table), local wagering game administration device, or group of remote devices.

The gaming establishment (e.g., the “house”) may take a “rake” (e.g., a commission for the house) on at least one wager, such as the poker pot wager, as indicated at operation 206, the at least one game wager, as indicated at operation 207, or both. In some embodiments, therefore, a rake may be taken on all wagers, or any wager. For example, the house may collect a portion of the poker pot wager at the time the poker pot wager is placed, with the remainder added to the poker pot. Additionally or alternatively, the house may collect a portion of the game wagers at the time the game wagers are placed, with the remainders added to the game pot.

The rake may comprise, for example, a fixed percentage of the wagers. More specifically, the percentage of the wagers collected for the rake may be, for example, greater than a theoretical house advantage for the underlying game. As another example, the rake may be less than an average house advantage for play of the wagering game by all players, including average and sub-average players, which may be calculated using a historical house advantage for the wagering game (e.g., a house advantage for the wagering game over the last 5, 10, or 15 years for a given casino or other gaming establishment). As specific, nonlimiting examples, the percentage of the wagers (i.e., either or both of the poker pot wager and the at least one game wager) collected for the rake may be between 3% and 8%, between 4% and 7%, or between 5% and 6%. In other embodiments, the portion of the wagers collected for the rake may comprise a variable percentage of the wagers or may comprise a fixed quantity (e.g., a flat fee) irrespective of the total amount for the second wager, a fixed percentage with a cap, or a time-based fee for increments of time playing the wagering game. Thus, in lieu of, or in addition to, a rake taken on one or more wagers or from winnings, the house may be compensated in a number of other ways, including, without limitation, a flat fee per round of play, a percentage of wagers made with or without a cap, rental of a player “seat,” or otherwise as is known in the gaming art. All such compensation may be generally referred to as a “commission.”

All profits for the house may be made from the rake (or rakes or other commission) in some pooled pot embodiments. In such embodiments, wagers in excess of the rake are distributed either in the form of, for example, a progressive payout (as in a “player-pooled progressive” embodiment (FIG. 5), a dividend refund (as in a “dividend refund” embodiment (FIG. 6), or some combination thereof. Thus, the profits for the house are limited. Such limiting of profits for the house and redistribution of wagers back to one or more players may increase the attractiveness of the wagering game to both inexperienced and highly skilled players. Because the amount earned by the house is known, highly skilled players may perceive that their skill will enable them to increase winnings, and inexperienced players may be enticed by the possibility of winning or otherwise earning a portion or all of one or more of the pots. In other embodiments, the house may make profits on the rake and on losses from one or more of the wagers (e.g., ante wagers, blind wagers, play wagers, side wagers), including losses resulting from optimal and suboptimal play.

The rake may be maintained in a rake account, and profits for the house may be deducted from the rake account. When and if taken from the poker pot wagers, the poker pot rake (operation 206) may be taken by, for example, electronically transferring funds from the poker pot wagers or the poker pot itself to a poker pot rake account (e.g., as instructed by a game server 606 (see FIG. 10) using casino account servers 610 (see FIG. 10)) or physically removing or exchanging money or representations of money from the poker pot wagers or the poker pot itself on a live table. Likewise, when and if taken from the game wagers, the game pot rake (operation 207) may be taken by, e.g., electronically transferring funds from the game pot wagers or the game pot itself to a game pot rake account (e.g., as instructed by the game server 606 (see FIG. 10) using casino account servers 610 (see FIG. 10)) or physically removing or exchanging money or representations of money from the game wagers or the game pot itself on a live table.

In some embodiments, the poker pot wager may be accepted (operation 202) at the beginning of a round of administration of the wagering game. At least one of the game wagers may be accepted (operation 204) at the beginning of the round as well with, e.g., the ante, blind, and side wagers. In some embodiments, additional game wagers may be accepted (operation 204), possibly raked (operation 207), and added to the game pot (operation 205) in the intermediate segments of the round of play (e.g., play wagers).

The underlying wagering game may be played as described above, including resolving the game wagers received during the round of play, as indicated at operation 208. For example, the underlying wagering game may be played at least substantially as described previously in connection with FIGS. 1 through 3. Payouts to be distributed, as a result of resolving the game wagers, (e.g., the ante, blind, play, and side wagers), are paid from the game pot.

It is contemplated that only a portion of the game pot may be distributed, at operation 208, in the form of payouts on the underlying game. At least in embodiments in which the game pot is configured as a progressive pot (e.g., if one of the game wagers is a progressive wager), all or substantially all of the remaining portion of the game pot may be designated for a potential progressive payout. For example, administering the player-pooled progressive embodiment of the pooled pot method 200 may include determining whether a progressive-winning condition has occurred, as indicated at operation 210. A progressive-winning condition may be predefined as predetermined winning hand combination being dealt or a premium winning hand composition being dealt. If such a progressive-winning condition has occurred during the round of game administration, a progressive payout may be awarded to the winning-hand-holding player, with the progressive payout being paid from the game pot, as indicated at operation 212. As just one example, a game may pay a progressive payout for a five-card royal flush, derived from seven cards dealt for the player hand. If no progressive-winning condition has occurred, a progressive payout may not be paid from the game pot, but, rather, the game pot balance may be carried forward for the next round of play and so on, as indicated at operation 214, until a progressive-winning condition occurs during a subsequent round. Thus, the game pot may not be awarded at the end of each round of play, but may grow during each successive round in which no player is dealt a predetermined winning hand combination or a premium winning hand composition. However, if the underlying game payouts are distributed at operation 208, or if a progressive payout is awarded at operation 212, without draining the game pot, the game pot may decrement until such time as the game pot contributions, at operation 205, rebuild the game pot.

A predetermined winning hand combination may comprise, for example, a four-of-a-kind, a full house, a flush, a straight, a three-of-a-kind, two pair, or one pair. The hands qualifying as new winning hand combinations may be predetermined at the beginning of each round of play in some embodiments. In other embodiments, new winning hand combinations may be predetermined at the beginning of play and may remain fixed until it is determined that at least one player hand achieves a predetermined winning hand combination, at which time new winning hand combinations may be predetermined. In still other embodiments, the hand combinations qualifying as winning hand combinations may be predetermined at the outset of the wagering game and remain fixed for the duration of the wagering game. The hands qualifying as winning hand combinations may be predetermined at random from a list of possible winning hand combinations, from among a schedule with a fixed rotation of possible winning hand combinations, or using a fixed table of winning hand combinations.

A premium winning hand composition may comprise, for example, a four-of-a-kind, a straight flush, or a royal flush. The hand compositions qualifying as premium winning hand compositions may remain fixed throughout the duration of the wagering game or may change during the wagering game. For example, after it has been determined that a player hand has achieved a premium winning hand composition, the hand compositions qualifying as premium winning hand compositions may be made more restrictive or less restrictive. As a specific, nonlimiting example, after identification of a player hand achieving a straight flush, the hand compositions qualifying as premium winning hand compositions may be restricted to royal flushes or may be expanded to include four-of-a-kinds. The hands qualifying as premium winning hand compositions may be predetermined at random from a list of possible premium winning hand compositions, following a schedule with a fixed rotation of possible premium winning hand compositions, or according to a fixed table of premium winning hand compositions.

In embodiments in which the game pot is a progressive pot, the amount awarded from the game pot for achieving a premium winning hand composition may be a progressive payout at least as great as a maximum progressive payout for achieving a predetermined winning hand composition. For example, the entire game pot may be awarded when a player or multiple players are dealt a premium winning hand composition, and only a portion of the game pot may be awarded when a player or multiple players are dealt a predetermined winning hand combination.

Awarding the game pot or a portion of the game pot may comprise crediting a player account with funds from the game pot or may comprise distributing physical money or physical representations of money from the game pot to the player.

Before, between, or after resolving the game wagers (operation 208), determining whether a progressive-winning condition occurred (operation 210), awarding a progressive payout (operation 212), or any combination thereof, the poker pot wager may be resolved, and the poker pot may be awarded to at least one player, as indicated at operation 216. Each successive round of receiving wagers, dealing cards, and resolving wagers may constitute a round of play, and the poker pot may be awarded to at least one player before the end of each round of play. The player to whom the poker pot is awarded may hold the highest ranking hand of all the participating player hands at the table. For example, if a player holds a five-card royal flush, derived from seven cards available for the player hand, and outranks all other participating player hands, the dealer may award the poker pot to the holder of the royal flush.

Awarding the poker pot or the portion of the poker pot may comprise crediting a player account of each winning player or may comprise distributing physical money or physical representations of money to each winning player.

In some embodiments, an entire amount of the poker pot may be awarded to at least one player before the end of each round of play. In such embodiments, the poker pot may be a non-progressive pot. Awarding the entire poker pot to at least one player at the end of each round of play may enable an online implementation of the wagering game to qualify as a legal form of online gambling under relevant statutes. For example, in games that require a mandatory pot bet that has no house advantage, and all other game wagers are raked with remainders going into a second pot, the game may qualify as “poker” to gaming authorities, especially for online versions of the games. Awarding the entire amount of a poker pot to at least one player at the end of each round of play redistributes lost poker wagers attributable to suboptimal play to other players, rather than to the house. Accordingly, such a wagering game may be particularly attractive to players who perceive themselves as being highly skilled in the wagering game and, therefore, more able to take advantage of suboptimal play by other players.

In some embodiments, a portion of the poker pot may be awarded to at least one player at the end of each round of play (operation 216). For example, the house may take a rake on the poker wager (operation 206), which may still enable the wagering game to qualify as a legal form of online gambling under relevant statutes. The rake taken may comprise, for example, between 1% and 8%, between 2% and 6%, or between 3% and 5% of the first wager. The rake amounts on each wager may be more than, less than, or equal to the rake taken on other wagers in some embodiments.

In still other embodiments, a portion of the poker pot may remain in the poker pot or may be redistributed to another pot (e.g., the game pot) to be awarded in a subsequent round of play as a progressive payout or as a dividend refund (see FIG. 6). In such an example, the portion of the poker pot wager remaining in the poker pot or redistributed to another pot may comprise, for example, a fixed percentage of the poker pot wager, a variable percentage of the poker pot wager (e.g., an odds payout may be awarded and the remainder retained in the poker pot or redistributed to the other pot), or a fixed amount.

In some embodiments involving a no-house-advantage poker pot awarded at the end of each round and a progressive game pot that receives all other game wagers, all players participating in the wagering game from whom the at least one game wager has been received may be eligible to win the game pot or a portion of the game pot. Players who are ineligible to win the poker pot, and players from whom fold indications have been received but from whom one or more other active wagers in play have been received, may be eligible to win the game pot or a portion of the game pot.

In some embodiments, the game pot may be seeded with money from the game pot rake account or a reserve account (as indicated at operation 218) at the beginning of play, after the game pot or a portion of the game pot has been awarded, or both. In some embodiments, a minimum account balance sufficient to cover expected losses is retained when distributing a progressive payout (operation 212) such that no seed money is required in the game pot. For example, the game pot may be seeded from the rake account of the house (operation 218), and the house may maintain an amount of funds in the rake account sufficient to significantly reduce (e.g., to essentially eliminate) the likelihood that any payouts made from the rake account and any seeding amounts withdrawn from the rake account exhaust or overdraw the rake account. In some embodiments, a casino reserve account may be provided to fill the rake account in the event of an overdraw. Such seeding may incentivize players to participate in the wagering game, and specifically to place a game wager (e.g., a progressive wager) to be eligible for the progressive payout from the game pot. In addition, such seeding may reduce the likelihood that the amount of funds in the game pot may be insufficient to cover all the payouts to players. For example, where a player hand achieves a premium winning hand composition in one round of play, a player hand achieves a predetermined winning hand combination in the immediately following round of play, and a fixed odds payout is to be awarded to the player holding the predetermined winning hand combination, the amount seeded to the game pot between those rounds of play may be at least as great as the maximum fixed odds payout awardable for any predetermined winning hand combination. The game pot may be seeded each time the game pot is awarded in its entirety or each time the amount in the game pot is lower than the maximum fixed odds payout.

As a specific, nonlimiting example, a pooled pot wagering game with a player-pooled progressive configuration may comprise receiving the ante and blind wagers, and adding the wagers to a game pot. Game play election events are conducted as described above. A poker wager may be taken and added to a poker pot. Some or all of the wagers may be raked to provide a house commission. At the end of the round of the wagering game, wins on the ante, blind, and play wagers are paid out of the game pot, while losses are kept in the game pot. The poker pot is distributed to the player holding the highest hand of the participating players. Optionally, a progressive side wager may be received (before the round) and added to a progressive pot, and if a player hits a predetermined winning condition, the progressive pot may be awarded to the player. The progressive side wager may or may not be raked, and a portion of the progressive pot may be retained as seed money.

For example, the game may include two pots. The first pot may be distributed after each round (e.g., after seven cards have been dealt to each player) to a single player achieving a winning result or may be split between two or more players. For example, the first pot may be distributed to the player having the highest-ranking five-card poker hand. The game pot may be a progressive pot that is distributed whenever any player achieves a predetermined hand ranking. For example, the game pot may be distributed to a player having a straight flush or better. The game pot may accumulate pot wagers until this distribution condition is met. The pot wagers may have no house advantage, in that all pot wagers are eventually distributed to players. In other embodiments, the pot wagers may be raked, such that the house takes a commission thereon.

Referring to FIG. 6, shown is a flowchart diagram of a method 220 of administering a wagering game, which may be at least partially a pooled pot wagering game, according to a dividend-refund embodiment. The method 220 is largely the same as the method 200 of the player-pooled progressive (FIG. 5), with the exception that, rather than determining whether a progressive-winning condition has occurred (operation 210 (FIG. 5)), the method 220 includes determining whether a trigger event condition has occurred, as indicated at operation 222, and, if so, distributing the game pot to one or more past or present players of the wagering game, as indicated at operation 224 (rather than distributing the game pot as a progressive payout as at operation 212 (FIG. 5)). In such embodiments, the game pot may accumulate between rounds of play, and, to periodically reduce the balance, a dividend (e.g., a share of the game pot awarded to each participating player) may be awarded to players from the game pot. Thus, what would otherwise be the profits from lost wagers, less amounts raked by the house, are redistributed back to the players, rather than collected by the house as revenue. Thus, the distribution is not a payout on the underlying game, but a refund.

The game pot, which may include all game pot wagers accepted during the round less any game pot rake taken, may be distributed among a plurality of players upon the occurrence of a predetermined event (referred to herein as a “trigger event”), as indicated at operation 222. The predetermined, trigger event may not be based, for example, on player skill or chance events occurring in the underlying wagering game. The predetermined trigger event may comprise, for example, determination that at least one player participated for a predetermined number of hands; completed a predetermined number of rounds of play at a given table, electronic gaming machine, or remote gaming device; reached a predetermined time limit since play commenced; or reached a predetermined amount within the game pot. The predetermined trigger event or condition may be time-based, pot-based (or pool-based), game-based, or other-based. Further details on pot distributions based on predetermined trigger events and conditions are disclosed in U.S. patent application Ser. No. 13/871,824, filed Apr. 26, 2013, titled “Distributing Supplemental Pot in Wagering Games Based on Predetermined Event,” the disclosure of which is incorporated herein in its entirety by this reference.

The dividend distributions may be divided at least among players currently participating in the wagering game. In some embodiments, the dividend distributions may also be paid to players who previously contributed to the game pot but who have since ceased participating in the wagering game. In some embodiments, the dividend distributions may not be paid to players from whom contributions to the game pot have not been received since the last dividend distribution was paid. The percentage of the game pot (e.g., all accepted wagers added to the game pot tally, less the rake) refunded to each player as a dividend distribution may be, for example, approximately equal to the percentage of hands won by each player, the percentage of first pot winnings won by each player based on game play, the percentage of total wager amounts received from each player, the proportional number of wagers received from each player, the proportional length of time spent playing the wagering game by each player, or an equal percentage for each player eligible to receive a dividend distribution from the game pot.

The dividend refund may be distributed in the form of a credit made to the receiving players' accounts. In some embodiments, the refund may be paid without concurrently alerting the player, though the refund may be noticeable when and if the player next checks his or her balance in his or her player account.

As another specific, nonlimiting example, a pooled pot wagering game with a dividend-refund configuration may comprise a game pot that is distributed, in the form of a dividend refund, whenever a predetermined event occurs. For example, the game pot may be distributed when a predetermined number of hands have been completed, a predetermined number of rounds have been administered, a predetermined amount of time has passed, or when the total value of wagers in the pot reaches a predetermined amount. The game pot may accumulate pot wagers until the distribution condition is met. When the predetermined event occurs, the game pot may be distributed pro-rata to all players having contributed to the game pot. For example, dividends may be transferred to each contributing player's player account. The players may not be actively engaged in a round of the wagering game to qualify for receipt of the dividend refund. The pot wagers may have no house advantage, in that all pot wagers are eventually distributed to players. In other embodiments, the pot wagers may be raked, such that the house takes a commission thereon.

In some embodiments, wagering games may be administered, e.g., over a network, without players risking money in connection with the wagers (i.e., “play-for-fun” games). Access to play-for-fun wagering games may be granted on a time-period basis in some embodiments. For example, upon initially joining the wagering game, each player may automatically be given wagering elements, such as, for example, chips, points, or simulated currency of no redeemable value. After joining, the player may be permitted to place bets using the wagering elements, and a timer may track how long the player has been participating in the wagering game. If the player exhausts his or her supply of the wagering elements before a predetermined period of time has expired, the player may be permitted to simply wait until the period of time passes to rejoin the game, at which time another quantity of the wagering elements may be distributed to the player to permit the player to resume participation in the wagering game.

In some embodiments, a hierarchy of players may determine the quantity of wagering elements given to a player for each predetermined period of time. For example, players who have been participating in the wagering game for a longer time, who have played closest to optimal strategy for the game, who have won the largest percentage of wagers, who have wagered the most in a play-for-pay environment, or who have won the largest quantities of wagering elements from their wagers may be given more wagering elements for each allotment of time than players who have newly joined, who have played according to poor strategy, who have lost more frequently, or who have lost larger quantities of wagering elements. In some embodiments, the hierarchy of players may determine the duration of each allotment of time. For example, players who have been participating in the wagering game for a longer time, who have played closest to optimal strategy for the game, who have won the largest percentage of wagers, or who have won the largest quantities of wagering elements from their wagers may be given shorter allotments of times to wait for an award of more wagering elements than players who have newly joined, who have played according to poor strategy, who have lost more frequently, or who have lost larger quantities of wagering elements. In some embodiments, players who have not run out of wagering elements after the period of time has expired may have the balance of their wagering elements reset for a subsequent allotment of time. In other embodiments, players who have not run out of wagering elements may be allowed to retain their remaining wagering elements for subsequent allotments of time, and may be given additional wagering elements corresponding to the new allotment of time to further increase the balance of wagering elements at their disposal. Players may be assigned to different categories of players, which determine the number of wagering elements awarded. In a given period of time, higher level players, or players who have invested more time playing the game may be allotted more wagering elements per unit of time than a player assigned to a lower level group.

Therefore, in some embodiments, the wagering game may be administered by receiving wagers (e.g., ante, blind, play, side, and/or other game wagers) of no real-world monetary value, and payouts (e.g., ante, blind, play, side, and/or other game payouts) may be paid without transferring real-world monetary value to the players. Such embodiments, referred to herein as “free play-for-fun” embodiments are nonetheless contemplated as modes of carrying out the methods described herein.

In some embodiments, referred to herein as “social play-for-fun” embodiments, a player may be permitted to redeem an access token of no otherwise redeemable face value, such as, for example, points associated with a player account (e.g., social media account credits, online points associated with a transacting account, etc.), to compress the period of time and receive more wagering elements. The access tokens may be sold or may be given without directly exchanging money for the access tokens. For example, access tokens may be allocated to players who participate in member events (e.g., complete surveys, receive training on how to play the wagering game, share information about the wagering game with others), spend time participating in the wagering game or in a player account forum (e.g., logged in to a social media account), or view advertising. Thus, an entity administering social play-for-fun wagering games may not receive money from losing player wagers and may not take a rake on wagers, but may receive compensation through advertising revenue or through the purchase of access tokens redeemable for time compressions to continue play of the wagering game or simply to increase the quantity of wagering elements available to a player.

After receipt of an indication that a player has stopped participating in a play-for-fun wagering game, (e.g., a free play-for-fun embodiment, a social play-for-fun embodiment), any remaining quantities of the wagering elements may be relinquished by the player and retained by the administrator, in some embodiments. For example, receipt of an indication that the player has logged out of a play-for-fun wagering game administered over the Internet may cause any remaining wagering elements associated with a respective player to be lost. Thus, when the player rejoins the play-for-fun wagering game, the quantity of wagering elements given to the player for an allotment of time may not bear any relationship to the quantity of wagering elements held by the player when he or she quit playing a previous session of the wagering game. In other embodiments, upon receipt of an indication that a player has stopped playing, the quantity of wagering elements held by the player at that time may be retained and made available to the player, along with any additional quantities of wagering elements granted for new allotments of time, upon receipt of an indication that the player has rejoined the wagering game.

As a specific, nonlimiting example, a free play-for-fun wagering game may comprise receiving the ante and blind wagers and adding the play wagers to a game pot, though the wagers may not be real money or representations of real monetary value. Game play election events are conducted as described above. All accepted wagers are resolved, with any payouts paid to players being of no real-world monetary value.

As another specific, nonlimiting example, a social play-for-fun wagering game may comprise accepting from a player a payment for access to engage in the wagering game and providing the player, in return, with a limited time period of access to engage in the wagering game. During the time period, the wagering game may be administered as described above, with accepted wages holding no real-world monetary value and payouts paid holding no real-world monetary value. At the completion of the limited time period of access, the administrator may offer to sell additional access time. Thus, a monetary fee is accepted to provide access to the wagering game, but monetary value is not risked or awarded in the administration of the wagering game. Players may be permitted to share their results (e.g., wins, losses, amounts of winnings or losses, notable hands) with other players or with non-players and/or compare their results with the results of other players playing in the same game. For example, a leaderboard may be provided to compare rankings of all players of such a game.

Referring to FIG. 7, illustrated is an example of an individual electronic gaming device 300 (e.g., an electronic gaming machine (EGM)) configured for implementation of embodiments of wagering games according to the present disclosure. The individual electronic gaming device 300 may include an individual player position 314 that includes a player input area 332 configured to enable a player to interact with the individual electronic gaming device 300 through various input devices (not shown). The individual electronic gaming device 300 may include a gaming screen 374 configured to display indicia for interacting with the individual electronic gaming device 300, such as through processing one or more programs stored in memory 340 to implement the rules of game play at the individual electronic gaming device 300. In some embodiments, the gaming screen 374 may be configured to display the player areas 102, 102′ shown in FIGS. 3 and 4. Accordingly, game play may be accommodated without involving physical playing cards, poker chips, and/or live personnel. The action may instead be simulated by a control processor 350 operably coupled to the memory 340 and interacting with and controlling the individual electronic gaming device 300.

Although the figure has an outline of a traditional gaming cabinet, the individual electronic gaming device 300 may be implemented in any number of ways, including but not limited to, client software downloaded to a portable device, such as a smart phone, tablet, or laptop personal computer. The individual electronic gaming device 300 may also be a non-portable personal computer (e.g., a desktop or all-in-one computer) or other computing device. In some embodiments, client software is not downloaded but is native to the device, or is otherwise delivered with the device when distributed to a player.

A communication device 360 may be included and operably coupled to the control processor 350 such that information related to operation of the individual gaming device 300, information related to the game play, or combinations thereof may be communicated between the individual gaming device 300 and other devices (not shown) through a suitable communication media, such, as, for example, wired networks, Wi-Fi networks, and cellular communication networks.

The gaming screen 374 may be carried by a generally vertically extending cabinet 376 of the individual electronic gaming device 300. The individual electronic gaming device 300 may further include banners (not shown) configured to communicate rules of game play and/or the like, such as along a top portion 378 of the cabinet 376 of the individual electronic gaming device 300. The individual electronic gaming device 300 may further include additional decorative lights (not shown), and speakers (not shown) for transmitting and/or receiving sounds during game play. Further detail of an example of an individual electronic gaming device 300 (as well as other embodiments of tables and devices) is disclosed in U.S. Patent Application Publication No. 2013/0053117, published Feb. 28, 2013, and titled “Methods of Managing Play of Wagering Games and Systems for Managing Play of Wagering Games,” the disclosure of which is incorporated herein in its entirety by this reference.

Some embodiments may be implemented at locations that include a plurality of player stations. Such player stations may include an electronic display screen for display of game information, such as displaying virtual cards, virtual chips, and game instructions, and for accepting wagers and facilitating credit balance adjustments. Such player stations may, optionally, be integrated in a table format, may be distributed throughout a casino or other gaming site, or may include both grouped and distributed player stations. While some features may be automated through electronic interfaces (e.g., virtual cards, virtual chips, etc.), some features may remain in the physical domain. As such, the game play may be administered by a live dealer, a virtual dealer, or a combination of both.

Referring to FIG. 8, an example of a suitable table 400 configured for implementation of embodiments of wagering games according to the present disclosure is shown. The table 400 may include a playing surface 404, such as the playing surface 100 shown in FIG. 2. The table 400 may include a plurality of player stations 412a through 412g, such as the player areas 102, 102′ shown in FIGS. 3 and 4. Each player station 412a through 412g may include a player interface 416a through 416g, which may be used for displaying game information (e.g., game instructions, input options, wager information including virtual chips, game outcomes, etc.). Each player interface 416a through 416g may include a display screen in the form of a touch screen, which may be at least substantially flush with the playing surface 404 in some embodiments. Each player interface 416a through 416g may be coupled respectively with its own local game processor 414a through 414g (shown in dashed lines), although, in some embodiments, a central game processor 428 (shown in dashed lines) may be employed and may communicate directly to player interfaces 416a through 416g. In some embodiments, a combination of individual local game processors 414a through 414g and the central game processor 428 may be employed.

A communication device 460 (shown in dashed lines) may be included and may be operably coupled to one or more of the local game processors 414, the central game processor 428, or combinations thereof, such that information related to operation of the table 400, information related to the game play, or combinations thereof may be communicated between the table 400 and other devices (not shown) through a suitable communication media, such, as, for example, wired networks, Wi-Fi networks, and cellular communication networks.

The table 400 may further include additional features, such as a dealer chip tray 420, which may be used by the dealer to cash players in and out of the wagering game, whereas wagers and balance adjustments during game play may be performed using virtual chips. For embodiments using physical cards 406a, 406b, the table 400 may further include a card handling device 422 that may be configured to shuffle, read, and deliver physical cards for the dealer and players to use during game play or, alternatively, a card shoe configured to read and deliver cards that have already been randomized. For embodiments using virtual cards, such virtual cards may be displayed at the individual player interfaces 416a through 416g.

The table 400 may further include a dealer interface 418, which, like the player interfaces 414a through 414g, may include touch screen controls for assisting the dealer in administering the wagering game. The table 400 may further include an upright display 430 configured to display images that depict game information such as pay tables, hand counts, historical win/loss information by player, and a wide variety of other information considered useful to the players. The upright display 430 may be double sided to provide such information to players as well as to the casino pit.

Further detail of an example of a table and player displays is disclosed in U.S. Pat. No. 8,262,475, issued Sep. 11, 2012, and titled “Chipless Table Split Screen Feature,” the disclosure of which is incorporated herein in its entirety by this reference. Although an embodiment is described showing individual discrete player stations, in some embodiments, the entire playing surface 404 may be an electronic display that is logically partitioned to permit game play from a plurality of players for receiving inputs from, and displaying game information to, the players, the dealer, or both.

Referring to FIG. 9, another example of a suitable table 500 configured for implementation of embodiments of wagering games having a virtual dealer according to the present disclosure is shown. The table 500 may include player positions 514a through 514e that are arranged in a bank about an arcuate edge 520 of a video device 558 that may comprise a card screen 564 and a dealer screen 560. The dealer screen 560 may display a video simulation of the dealer (i.e., a virtual dealer) for interacting with the video device 558, such as through processing one or more stored programs stored in memory 595 to implement the rules of game play at the video device 558. The dealer screen 560 may be carried by a generally vertically extending cabinet 562 of the video device 558. The card screen 564 may be configured to display at least one or more of the dealer's cards, community cards, and/or player's cards by the virtual dealer on the dealer screen 560 (virtual dealer not shown in FIG. 9).

Each of the player positions 514a through 514e may include a player interface area 532a through 532e that is configured for wagering and game play interactions with the video device 558 and/or virtual dealer, and which may be configured as the player areas 102, 102′ shown in FIGS. 3 and 4. Accordingly, game play may be accommodated without involving physical playing cards, poker chips, and/or live personnel. The action may instead be simulated by a control processor 597 interacting with and controlling the video device 558. The control processor 597 may be located internally within, or otherwise proximate to, the video device 558. The control processor 597 may be programmed, by known techniques, to implement the rules of game play at the video device 558. As such, the control processor 597 may interact and communicate with display/input interfaces and data entry inputs for each player interface area 532a through 532e of the video device 558. Other embodiments of tables and gaming devices may include a control processor that may be similarly adapted to the specific configuration of its associated device.

A communication device 599 may be included and operably coupled to the control processor 597 such that information related to operation of the table 500, information related to the game play, or combinations thereof may be communicated between the table 500 and other devices (not shown) through suitable communication media, such as, for example, wired networks, Wi-Fi networks, and cellular communication networks.

The video device 558 may further include banners (not shown) configured to communicate rules of play and/or the like, which may be located along one or more walls 570 of the cabinet 562. The video device 558 may further include additional decorative lights (not shown) and speakers (not shown), which may be located on an underside surface 566, for example, of a generally horizontally depending top 568 of the cabinet 562 of the video device 558 generally extending toward the player positions 514a through 514e.

Further detail of an example of a table and player displays is disclosed in U.S. Pat. No. 8,272,958, issued Sep. 25, 2012, and titled “Automated Multiplayer Game Table with Unique Image Feed of Dealer,” the disclosure of which is incorporated herein in its entirety by this reference. Although an embodiment is described showing individual discrete player stations, in some embodiments, the entire playing surface (e.g., player interface areas 532a through 532e, card screen 564, etc.) may be an electronic display that is logically partitioned to permit game play from a plurality of players for receiving inputs from, and displaying game information to, the players, the dealer, or both.

Wagering games in accordance with embodiments of the disclosure may be administered over the Internet, or otherwise online, in one embodiment using a gaming system employing a client server architecture. Referring to FIG. 10, illustrated is a schematic block diagram of a gaming system 600 for implementing wagering games according to an embodiment of the present disclosure. The gaming system 600 enables end users to access proprietary and/or non-proprietary game content through a client 622 such as an online casino. Such game content may include, without limitation, various types of wagering games such as card games, dice games, big wheel games, roulette, scratch-off games (“scratchers”), and any other wagering game where the game outcome is determined, in whole or in part, by one or more random events. This includes, but is not be limited to, Class II and Class III games as defined under 25 U.S.C. §2701 et seq. (“Indian Gaming Regulatory Act”). Such games may include banked and/or non-banked games.

The wagering games supported by the gaming system 600 may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed, including, but not limited to, a player purchasing credits: being awarded credits as part of a contest or a win event in this or another game (including non-wagering games); being awarded credits as a reward for use of a product, casino or other enterprise, time played in one session, or games played; or may be as simple as being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites (client 622) having both play-for-fun and wagering games, including issuance of free (non-monetary) credits usable to play the play-for-fun games. This may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The gaming system 600 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming system 600 may include a gaming platform that establishes a portal for an end user to access a wagering game hosted by a client 622, which in one embodiment is an online casino. The gaming system 600 includes a game server that is accessed by the client 622 through a user interaction server 602. The user device 620 may communicate through client 622 with a user interaction server 602 of the gaming system 600 using a network 630 (e.g., the Internet) without being aware that the gaming system 600 is a separate system from the online casino client 622. The user interaction server 602 may communicate with the game server 606 and provide game information to the user on user device 620. In some embodiments, the game server 606 may also be a game engine. In some embodiments, a single user device 620 communicates with a game provided by the game server 606, while other embodiments may include a plurality of user devices 620 configured to communicate and provide end users with access to the same game provided by the game server 606. In addition, a plurality of end users may be permitted to access a single user interaction server 602, or a plurality of user interaction servers 602, to access the game server 606.

The user interaction server 602 may communicate with the user device 620 through the client 622 to enable access to the gaming system 600. The user interaction server 602 may enable a user to create and access a user account and interact with gaming server 606. The user interaction server 602 may enable users to initiate new games, join existing games, and interface with games being played by the user.

The user interaction server 602 may also provide a client 622 for execution on the user device 620 for accessing the gaming system 600. The client 622 provided by the gaming system 600 for execution on the user device 620 can comprise a variety of implementations according to the user device 620 and method of communication with the gaming system 600. In one embodiment, the user device 620 connects to the gaming system 600 using a web browser, and the client 622 executes within a browser window or frame of the web browser. In another embodiment, the client 622 is a stand-alone executable on the user device 620.

In one embodiment, the client 622 may comprise a relatively small amount of script (e.g., JAVASCRIPT®), also referred to as a “script driver,” including scripting language that controls an interface of the client 622. The script driver may include simple function calls requesting information from the gaming system 600. In other words, the script driver stored in the client 622 may merely include calls to functions that are externally defined by, and executed by, the gaming system 600. As a result, the client 622 may be characterized as a “thin client.” As that term is used herein, the client 622 may be little more than a script player. The client 622 may simply send requests to the gaming system 600 rather than performing logic itself. The client 622 receives player inputs, and the player inputs are passed to the gaming system 600 for processing and executing the wagering game. In one embodiment, this includes providing specific graphical display information to client 622, as well as game outcomes. In some embodiments the online casino system is the client 622, and assets from the asset server 604 of the gaming system 600 are combined with assets of the online casino system to form a custom display that creates the appearance that games operating on gaming system 600 are hosted by the client 622.

In other embodiments, the client 622 comprises an executable file rather than a script. In that case, client 622 may do more local processing than does a script driver, such as calculating where to show what game symbols upon receiving a game outcome from game server 606 through user interaction server 602. In one embodiment, portions of an asset server 604 are loaded onto the client 622 and are used by the client 622 in processing and updating graphical displays. Due to security and integrity concerns, most embodiments will have the bulk of the processing of the game play performed in the gaming system 600. However, some embodiments may include significant game processing by client 622 when the client and user device 620 are considered trustworthy or when there is reduced concern for security and integrity in the displayed game outcome. In most embodiments, it is expected that some form of data protection, such as end-to-end encryption, will be used when data is transported over network 630. Network 630 may be any network, including, but not limited to, the Internet.

In an embodiment where the client 622 implements further logic and game control methodology beyond the thin client, the client 622 may parse and define player interactions prior to passing the player interactions to the gaming system 600. Likewise, when the client 622 receives a gaming interaction from the gaming system 600, the client 622 may be configured to determine how to modify the display as a result of the gaming interaction. The client 622 may also allow the player to change a perspective or otherwise interact with elements of the display that do not change aspects of the game.

The gaming system 600 may include an asset server 604, which may host various media assets (e.g., audio, video, and image files) that may be sent to the client 622 for presenting the various wagering games to the end user. In other words, in this embodiment the assets presented to the end user may be stored separately from the client 622. In one embodiment, the client 622 requests the assets appropriate for the game played by the user; in other embodiments, especially those using thin clients, just those assets that are needed for a particular display event will be sent by game server 606 when the game server 606 determines they are needed, including as few as one asset. In one example, the client 622 may call a function defined at the user interaction server 602 or asset server 604, which may determine which assets are to be delivered to the client 622 as well as how the assets are to be presented by the client 622 to the end user. Different assets may correspond to the various clients that may have access to the game server 606 or to different games to be played.

The game server 606 is configured to perform game play methods and determine game play outcomes that are provided to the user interaction server 602 to be transmitted to the user device 620 for display on the end user's computer. For example, the game server 606 may include game rules for one or more wagering games, such that the game server 606 controls some or all of the game flow for a selected wagering game as well as the determined game outcomes. The game server 606 may include pay tables and other game logic. The game server 606 also performs random number generation for determining random game elements of the wagering game. In one embodiment, the game server 606 is separated from the user interaction server 602 by a firewall or other method of preventing unauthorized access to the game server 606 from the general members of the network 630.

The user device 620 may present a gaming interface to the player (e.g., the player areas 102, 102′ shown in FIGS. 3 and 4) and communicate the user interaction to the gaming system 600 or to the online server-based casino (client 622). The user device 620 may be any electronic system capable of displaying gaming information, receiving user input, and communicating the user input to the gaming system 600. As such, the user device 620 can be a desktop computer, a laptop, a tablet computer, a set-top box, a mobile device (including, but not limited to, a smart phone), a kiosk, a terminal, or another computing device. The user device 620 operating the client 622 may comprise an interactive electronic gaming system 300 (see FIG. 7), as described above. The client 622 may be a specialized application or may be executed within a generalized application capable of interpreting instructions from an interactive gaming system, such as a web browser.

The client 622 may interface with an end user through a web page, or an application that runs on a device including, but not limited to, a smart phone, a tablet, or a general computer, or the client 622 may be any other computer program configurable to access the gaming system 600. The client 622 may be illustrated within a casino webpage (or other interface) indicating that the client 622 is embedded into a webpage, which is supported by a web browser executing on the user device 620.

In one embodiment, the gaming system 600 and the online casino comprising the client 622 may be operated by different entities. The user device 620 may be operated by a third party, such as a casino or an individual, that links to the gaming system 600, which may be operated, for example, by a wagering game service provider. Therefore, in some embodiments, the user device 620 and client 622 may be operated by a different administrator than the operator of the gaming system 600. In other words, the user device 620 may be part of a third-party system that does not administer or otherwise control the gaming system 600 or game server 606. In other embodiments, the client 622 is part of an online server based casino, and is a separate entity from the owner of the user device 620 or the gaming system 600. In another embodiment, the user interaction server 602 and asset server 604 are provided by a third-party system. For example, a gaming entity (e.g., a casino) may operate the user interaction server 602 or user device 620 to provide its customers access to game content managed by a different entity that may control game server 606, amongst other functionality. In some embodiments, these functions are operated by the same administrator. For example, a gaming entity (e.g., a casino) may elect to perform each of the functions of the gaming system 600 in-house, such as providing both the access to the user device 620 and the actual game content and providing administration of the gaming system 600.

The gaming system 600 may communicate with one or more external account servers 610, optionally through another firewall. For example, the gaming system 600 itself may not directly accept wagers or issue payouts. That is, the gaming system 600 may facilitate online casino gaming, but may not be part of a self-contained online casino itself. Instead, the gaming system 600 may facilitate the play of wagering games owned and controlled by a company offering games and gaming products and services, such as SHFL Entertainment, Inc., of Las Vegas, Nev. Another entity (e.g., a casino or any account holder or financial system of record) may operate and maintain its external account servers 610 as part of a server-based online casino and may accept bets and make payout distributions. The gaming system 600 may communicate with the account servers 610 to verify the existence of funds for wagering and to instruct the account server 610 to execute debits and credits.

In some embodiments, the gaming system 600 may directly accept bets and make payout distributions, such as in the case where an administrator of the gaming system 600 operates as a casino. As discussed above, the gaming system 600 may be integrated within the operations of a casino rather than separating out functionality (e.g., game content, game play, credits, debits, etc.) among different entities. In addition, for play-for-fun wagering games, the gaming system 600 may issue credits, take bets, and manage the balance of the credits according to the game outcomes, but the gaming system 600 may not permit payout distributions or be linked to an account server 610 that permits payout distributions. Such credits may be issued for free, through purchase, or for other reasons, without the ability for the player to cash out. Such play-for-fun wagering games may be administered on platforms that do not permit traditional gambling, such as to comply with laws in jurisdictions that do not permit online gambling.

The gaming system 600 may be configured in many ways, from a fully integrated single system to a distributed server architecture. The asset server 604, the user interaction server 602, the game server 606, and the account server 610 may be configured as a single, integrated system of code modules running on a single server or machine, where each of the servers is functionally implemented on a single machine. In such a case, the functionality described herein may not be implemented as separate code modules. The asset server 604, the user interaction server 602, the game server 606, and the account server 610 may also be implemented as a plurality of independent servers, each using its own code modules running on a separate physical machine, and may further include one or more firewalls between selected servers (depending on security needs). Each server could communicate over some kind of networked connection, potentially as varied as that described for network 630. Further, each single server shown in FIG. 10 may be implemented as a plurality of servers with load balancing and scalability factors built into the embodiment. All such embodiments and variations are fully contemplated.

Additional features may be supported by the game server 606, such as hacking and cheating detection, data storage and archival, metrics generation, messages generation, output formatting for different end user devices, as well as other features and operations. For example, the gaming system 600 may include additional features and configurations as described in U.S. Patent Application Publication No. 2013/0184079, published Jul. 18, 2013, and titled “Network Gaming Architecture, Gaming Systems, and Related Methods;” and U.S. Patent Application Publication No. 2013/0184059, published Jul. 18, 2013, and titled “Network Gaming Architecture, Gaming Systems, and Related Methods;” the disclosures of which are incorporated herein in their entirety by this reference.

The network 630 may enable communications between the user device 620 and the gaming system 600. The network may also enable communications between the user device 620 and the online casino comprising the client 622, and the online casino comprising the client 622 and the gaming system 600. A network (not shown) may also connect the gaming system 600 and account server 610, and, further, one or more networks (not shown) may interconnect one or more of the other servers shown collectively as the game system 600. In one embodiment, the network 630 uses standard communications technologies and/or protocols. Thus, the network 630 can include links using technologies such as Ethernet, 802.11, worldwide interoperability for microwave access (WiMAX®), 3G, 4G, digital subscriber line (DSL), asynchronous transfer mode (ATM), INFINIBAND®, PCI Express Advanced Switching, etc. Similarly, the networking protocols used on the network 630 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 630 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, the network 630 can include links comprising one or more networks such as the Internet.

Referring to FIG. 11, a high-level block diagram of a computer system 640 for acting as the gaming system 600 (see FIG. 10) according to one embodiment is shown. Illustrated are at least one processor 642 coupled to a chipset 644, as indicated in dashed lines. Also coupled to the chipset 644 are memory 646, a storage device 648, a keyboard 650, a graphics adapter 652, a pointing device 654, and a network adapter 656. A display 658 is coupled to the graphics adapter 652. In one embodiment, the functionality of the chipset 644 is provided by a memory controller hub 660 and an I/O controller hub 662. In another embodiment, the memory 646 is coupled directly to the at least one processor 642 instead of to the chipset 644.

The storage device 648 is any non-transitory computer-readable storage medium, such as a hard drive, a compact disc read-only memory (CD-ROM), a DVD, or a solid-state memory device (e.g., a flash drive). The memory 646 holds instructions and data used by the processor 642. The pointing device 654 may be a mouse, a track pad, a track ball, or another type of pointing device, and it is used in combination with the keyboard 650 to input data into the computer system 640. The graphics adapter 652 displays images and other information on the display 658. The network adapter 656 couples the computer system 640 to a local or wide area network.

As is known in the art, the computer system 640 can have different and/or other components than those shown in FIG. 11. In addition, the computer system 640 can lack certain illustrated components. In one embodiment, the computer system 640 acting as the gaming system 600 (FIG. 10) lacks the keyboard 650, pointing device 654, graphics adapter 652, and/or display 658. Moreover, the storage device 648 can be local and/or remote from the computer system 640 (such as embodied within a storage area network (SAN)). Moreover, other input devices, such as, for example, touch screens may be included.

The network adapter 656 (may also be referred to herein as a “communication device”) may include one or more devices for communicating using one or more of the communication media and protocols discussed above with respect to FIG. 10.

In addition, some or all of the components of this general computer system 640 of FIG. 11 may be used as part of the processor and memory discussed above with respect to the systems of FIGS. 7, 8, and 9.

The gaming system 600 (FIG. 10) may comprise several such computer systems 640. The gaming system 600 may include load balancers, firewalls, and various other components for assisting the gaming system 600 to provide services to a variety of user devices.

As is known in the art, the computer system 640 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 648, loaded into the memory 646, and executed by the processor 642.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

Some portions of the disclosure are presented in terms of algorithms (e.g., as represented in flowcharts, prose descriptions, or both) and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of acts (instructions) leading to a desired result. The acts are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of acts requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “computing,” “calculating,” “determining,” “displaying,” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process acts and instructions described herein in the form of an algorithm. It should be noted that the process acts and instructions of the embodiments can be embodied in software, firmware, or hardware, and when embodied in software, could be downloaded to reside on and be operated from different platforms used by a variety of operating systems. The embodiments can also be in a computer program product that can be executed on a computing system.

Some embodiments also relate to an apparatus for performing the operations herein. Such an apparatus may be specially constructed for the purposes, e.g., a specific computer, or it may comprise a general-purpose computer selectively activated or reconfigured by a computer program stored in the computer. Such a computer program may be stored in a computer-readable storage medium, such as, but not limited to, any type of disc including floppy disks, optical discs, CD-ROMs, magnetic-optical discs, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information, data, and/or programs and can be a transient or non-transient medium, where a non-transient or non-transitory medium can include memory (storage) that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method acts. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for the purposes of enablement and best mode.

### EXAMPLES

### Example 1

### Cincinnati 7 Card Stud™

One example of game play described herein (referred to under the game nomenclature of “CINCINNATI 7 CARD STUD”™) can be played with one or more of the player areas 102 shown in FIG. 3, and is described as follows. An ante wager is received from a player, and preferably at least two initial equal wagers are received—an ante wager and a blind wager. The ante wager is mandatory to participate in the game. The blind wager may also be mandatory. An optional side wager (referred to herein as a “Straight Up” wager) may be accepted and may be designated to be resolved based on the player's resulting five-card hand having at least a minimum hand rank of a straight. The administrator also pays bonus payouts according to a pay table for straights and for other higher-ranking hands. According to an example of the game, the administrator deals each player three cards face down to a player position. The administrator (or dealer, banker, etc.) may receive a complete seven-card dealer hand (face down). In other embodiments, the administrator receives three cards (face down), and then a group of four cards (face down), which are combined before the dealer or player sees the cards.

After seeing his or her first three cards, the player is provided a specific choice—check (remain in the game without risking additional wagers) or make a specific play wager amount, referred to herein as a “3^{rd} Street” bet (in reference to the three cards the player has). For example, the 3^{rd} Street bet may be precisely a 3× wager (where the “×” indicates a multiple of the ante wager). In this example, the administrator prohibits the players from folding.

With each subsequent game play election event, the amounts of the permitted play wagers decrease. The players may, therefore, be rewarded for risking larger amounts earlier in the game, when less information about the outcome is available for the players. Players can also accept less risk by checking. With each successive game play election event, more information becomes available to the players regarding the quality of each player's own hand, and lesser amounts are permitted to be wagered.

Whatever the players' election (bet or check), the administrator may then deal each player another two cards. The administrator may also receive another two cards (face down) if the dealer hand has not already been completed. After viewing his or her two new cards, the player may be given an opportunity to make a second play bet, referred to herein as “5^{th} Street” (in reference to the five cards the players have) or check. The 5^{th} Street bet may be required to be in a certain amount and may be in an amount less than the 3^{rd} Street bet (e.g., 2× the ante wager). The administrator may also receive a check election from the player if the player does not wish to place the 5^{th} Street bet.

Whatever the players' election (bet or check), the administrator may then deal the player a final two cards. The administrator may also receive another two cards (face down) if the dealer hand has not already been completed. After viewing his or her two new cards, the player knows all seven of the cards from which his or her best five-card hand will be determined. The administrator may provide the player an opportunity to make a third play bet, referred to herein as “7^{th} Street” (in reference to the seven cards the players have). The 7^{th} Street bet may be required to be in a certain amount and may be in an amount less than the 5^{th} Street bet (e.g., 1× the ante wager). The administrator may also provide an opportunity to check in lieu of placing the 7^{th} Street bet if the player has placed either or both of the 3^{rd} Street bet or the 5^{th} Street bet. The administrator may accept a third play wager regardless of prior wagering elections. The administrator may require the player to bet or fold if the player has placed neither the 3^{rd} Street bet nor the 5^{th} Street bet. The administrator takes the ante, blind, and Straight Up bets if the player folds.

The administrator then reveals his seven cards and identifies his best hand (best five-card hand). The administrator's best five of seven cards hand is compared to each player's best five of seven cards hand to determine head-to-head winners. In one form of the methods of the present disclosure, the administrator must qualify with a predetermined minimum card ranking of a pair or else return at least one wager to the player, such as the largest play wager. If the administrator, for example, does not qualify with a pair or better, the player's highest play wager (3^{rd} Street, 5^{th} Street, or 7^{th} Street) is returned to the player. However, the ante wagers, blind wagers, Straight Up bet, and any remaining play wagers are resolved in the normal manner. The administrator pays winning payouts on the Straight Up bet, regardless of whether the administrator qualifies.

When there is no administrator qualification act, then the administrator hand is compared to the player hand. If the player hand ranks higher than the administrator hand rank, the administrator pays even money on the ante bet (i.e., a 1:1 payout), pays even money for the blind bet for certain high-ranking hands, (i.e.—three of a kind or better) that beat the dealer hand, and pays odds on the Straight Up bet according to a pay table, such as is shown in Table 2:

TABLE 2
Straight Up wager payouts

| Player Hand Rank | Odds Payout |
|---|---|
| Royal flush | 300:1 |
| Straight flush | 50:1 |
| Four-of-a-kind | 25:1 |
| Full house | 9:1 |
| Flush | 8:1 |
| Straight | 7:1 |

The administrator also pays the player 1:1 on play bets when the player's hand beats the dealer's hand, and pushes when the player's hand ties the dealer's hand. The administrator takes the player's ante bet, blind bet and all play bets when the player's hand has a lower rank than the dealer's hand.

The mandatory blind bet is equal to the ante, in this embodiment. The administrator pays the player 1:1 on the blind bet when the player has a predetermined winning hand rank, for example, three-of-a-kind or higher, and the player's hand beats the administrator's hand. The administrator retains the blind bet when the administrator's hand beats the player's hand. The administrator pushes the blind bet when the player's hand ties the administrator's hand. The administrator also pushes the blind bet when the player's hand is less than three-of-a-kind but beats the dealer's hand.

### Example 2

### ULTIMATE 7 CARD STUD™ with Trips Wager Payouts Based on Hand Rank Comparison

Another example of game play described herein (referred to herein as “ULTIMATE 7 CARD STUD”™ and wherein a Trips wager has payouts defined based on a comparison of the player hand rank and the dealer hand rank) can be played with the player areas 102′ shown in FIG. 4A. The game may be administered as in Example 1 with the exception that, first, the optional side wager may be designated as a “Trips” bet to be resolved based at least in part on the player hand rank and a minimum hand rank of a three-of-a-kind and, second, the blind wager may be designated to be resolved based at least in part on a winning player hand rank (i.e., a player hand rank that exceeds a dealer hand rank) and a minimum hand rank of a flush.

Resolving the Trips optional side bet may include paying payouts, for meeting winning conditions, that are defined according to pay tables, such as shown in Table 3. For example, the Trips wager may pay different amounts depending on whether the player hand wins or loses against the dealer hand.

TABLE 3
Trips wager payouts

| Player Hand Rank | Win | Lose/Tie |
|---|---|---|
| Royal flush | 100:1 | n/a |
| Straight flush | 40:1 | 500:1 |
| Four-of-a-kind | 25:1 | 300:1 |
| Full house | 6:1 | 50:1 |
| Flush | 5:1 | 20:1 |
| Straight | 4:1 | 15:1 |
| Three-of-a-kind | 3:1 | 9:1 |

Resolving the blind wager may include paying a payout defined by a pay table, such as shown in Table 4, when the player hand rank at least equals the minimum rank of, e.g., a flush, and exceeds a dealer hand rank. The administrator retains the blind bet when the administrator's hand beats the player's hand. The administrator pushes the blind bet when the player's hand ties the administrator's hand. The administrator also pushes the blind bet when the player's hand is less than three-of-a-kind but beats the dealer's hand.

TABLE 4
Blind wager payouts

| Winning Player Hand Rank | Odds Payout |
|---|---|
| Royal flush | 200:1 |
| Straight flush | 40:1 |
| Four-of-a-kind | 8:1 |
| Full house | 2:1 |
| Flush | 3:2 |
| All others | Push |

### Example 3

### ULTIMATE 7 CARD STUD™ with Trips Wager Payouts Based on Player Hand Rank and Dealer Hand Qualification

Another example of game play described herein (referred to herein also as “ULTIMATE 7 CARD STUD”™ and wherein a Trips wager has payouts defined based on the player hand rank and a dealer hand qualification, without regard to a comparison of the player hand rank and the dealer hand rank) can be played with the player areas 102′ shown in FIG. 4B. The game may be administered as in Example 2 with the exception that, first, the “Trips” bet may be designated to be resolved based at least in part on the player hand rank, a minimum hand rank of three-of-a-kind, and whether a dealer hand rank at least equals a qualifying rank of a pair and, second, the blind wager may be resolved utilizing a different pay table. Accordingly, regardless of whether a player hand loses to, beats, or ties a dealer hand, the side wager may define payouts based on the player hand rank, with adjustment made based on dealer hand qualification.

Resolving the Trips optional side bet may include paying payouts, for meeting winning conditions, that are defined according to a pay table, such as shown in Table 5. For example, the Trips wager may pay different amounts, based on the player hand rank, depending on whether the dealer hand at least equals a qualifying rank, but without regard to whether the player hand rank beats, loses to, or ties the dealer hand rank.

TABLE 5
Sample side wager payouts

| Player Hand Rank | Odds Payout |
|---|---|
| Royal flush | 100:1* |
| Straight flush | 50:1* |
| Four-of-a-kind | 25:1* |
| Full house | 6:1* |
| Flush | 5:1* |
| Straight | 4:1* |
| Three-of-a-kind | 3:1* |

*Payout double if dealer has less than a pair

Resolving the blind wager may include paying a payout defined by a pay table, such as shown in Table 6, when the player hand rank at least equals the minimum rank of, e.g., a flush, and also exceeds the dealer hand rank. The blind wager may be lost if player hand rank does not exceed the dealer hand rank. Thus, the pay table may define the payout based at least in part on a winning player hand rank. The blind wager pushes if the player hand rank equals the dealer hand rank or if the player hand rank exceeds the dealer hand rank but is exceeded by the minimum rank of a flush.

TABLE 6
Blind wager payouts

| Player Hand Rank | Odds Payout |
|---|---|
| Royal flush | 250:1* |
| Straight flush | 40:1* |
| Four-of-a-kind | 8:1* |
| Full house | 2:1* |
| Flush | 3:2* |
| All others | Push* |

*Must beat dealer

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being within the scope of the disclosure, as contemplated by the inventors.

What is claimed is:

1. A method of administering a wagering game, comprising:
accepting an ante wager from a player;
dealing a number of cards to form a dealer hand;
dealing a group of cards for a player hand;
administering a first game play election event comprising:
providing a first set of game play election options comprising accepting a first play wager;
accepting from the player a first game play election comprising accepting a first play wager;
dealing at least one card to combine with the group of cards for the player hand;
administering a second game play election event comprising:
providing a second set of game play election options comprising accepting a second play wager;
accepting from the player a second game play election comprising accepting a second play wager;
dealing at least one other card to complete the player hand, the player hand consisting of the group of cards, the at least one card, and the at least one other card;
administering a third game play election event comprising:
providing a third set of game play election options comprising accepting a third play wager;
accepting from the player a third game play election comprising accepting a third play wager; and
resolving all accepted wagers, acceptance of at least one of the first play wager, the second play wager, and the third play wager being a prerequisite for paying a payout on any of the ante wager, the first play wager, the second play wager, and the third play wager.

2. The method of claim 1:
further comprising refunding to the player at least one of the first play wager, the second play wager, and the third play wager for a dealer hand rank exceeded by a predefined qualifying rank; and
wherein resolving all accepted wagers comprises, after refunding to the player at least one of the first play wager, the second play wager, and the third play wager, resolving all non-refunded accepted play wagers of the first play wager, the second play wager, and the third play wager.

3. The method of claim 2, wherein refunding to the player at least one of the first play wager, the second play wager, and the third play wager for a dealer hand rank exceeded by a predefined qualifying rank comprises refunding to the player at least one of the first play wager, the second play wager, and the third play wager for the dealer hand rank exceeded by a predefined qualifying rank equaling a pair.

4. The method of claim 1, wherein:
providing a first set of game play election options comprises providing a first set of game play election options comprising a first play wager of a first predefined amount;
providing a second set of game play election options comprises providing a second set of game play election options comprising a second play wager of a second predefined amount, the second predefined amount being less than the first predefined amount; and
providing a third set of game play election options comprises providing a third set of game play election options comprising a third play wager of a third predefined amount, the third predefined amount being less than the second predefined amount.

5. The method of claim 4, wherein:
providing a first set of game play election options comprising a first play wager of a first predefined amount comprises providing the first set of game play election options comprising the first play wager equal to three times the ante wager;
providing a second set of game play election options comprising a second play wager of a second predefined amount comprises providing the second set of game play election options comprising the second play wager equal to two times the ante wager; and
providing a third set of game play election options comprising a third play wager of a third predefined amount comprises providing the third set of play election options comprising the third play wager that is equal to the ante wager.

6. The method of claim 1, further comprising accepting from the player a blind wager equal to the ante wager.

7. The method of claim 6, wherein resolving all accepted wagers comprises resolving the blind wager, resolving the blind wager comprising:
paying a payout to the player for a player hand rank exceeding a dealer hand rank and the player hand rank at least equaling a predefined minimum winning blind rank.

8. The method of claim 7, wherein paying a payout to the player comprises paying a payout defined by a pay table and based at least in part on the player hand rank.

9. The method of claim 1:
further comprising accepting a side wager from the player, a winning condition for the side wager predefined as a player hand rank at least equaling a predetermined minimum side rank; and
wherein resolving all accepted wagers comprises resolving the side wager.

10. The method of claim 9, wherein resolving the side wager comprises paying a side payout to the player for the player hand meeting the winning condition, the payout defined by a pay table based at least in part on the player hand rank.

11. The method of claim 9, wherein resolving the side wager comprises:
paying a side payout to the player for the player hand meeting the winning condition, the payout defined by a pay table based at least in part on the player hand rank, and
selecting the payout from a pay table and based at least in part on relative ranking of the player hand rank and a dealer hand rank.

12. The method of claim 6, and further comprising paying the player a payout of 1:1 on the blind bet when the player hand is at least a three of a kind, and the player hand outranks the dealer hand.

13. The method of claim 6, and further comprising paying the player an odds payout on the blind bet when the player hand is at least a flush or better.

14. The method of claim 1, further comprising providing a gaming layout displaying a plurality of wagering areas, the plurality of wagering areas comprising an ante wager area, a blind wager area, and at least two play wager areas.

15. The method of claim 14, wherein accepting the ante wager from a player comprises accepting the ante wager at the ante wager area, the ante wager at least partially covering the ante wager area.

16. The method of claim 1, wherein the step of providing a first set of game play election options comprises accepting a first check election.

17. The method of claim 1, wherein the step of providing a second set of game play election options comprises accepting a second check election.

18. The method of claim 1, and further comprising accepting a first check election after the step of providing a first set of game play election options, and accepting a second check election after the step of providing a second set of game play election options, and further comprising accepting a fold election after the step of providing a third set of game play election options.

19. The method of claim 1, wherein at least one wager pays double when the dealer does not hold a hand of a predetermined qualifying rank.

20. The method of claim 6, and further comprising returning at least one of the ante, play wagers and the blind wagers when a dealer hand is equal in rank to a player hand.

21. A method of administering a poker-style game, comprising:
accepting an ante wager from a player;
dealing cards to form a dealer hand;
dealing other cards to form a player hand, comprising performing a first card distribution act, at least one intermediate card distribution act, and a final card distribution act;
after performing the first card distribution act, accepting a first game play election from the player, the first game play election selected from the group consisting of checking and placing a first play wager limited to a first amount;
after performing the at least one intermediate card distribution act, accepting a second game play election from the player, the second game play election selected from the group consisting of checking and placing a second play wager limited to a second amount less than the first amount;
after performing the final card distribution act:
accepting a third game play election based at least in part on the first game play election and the second game play election, the third game play election selected from the group consisting of checking, folding and placing a third play wager limited to a third amount less than the second amount; and
resolving all accepted wagers.

22. The method of claim 21, wherein the third game play election is folding when at least one of a first play wager election and a second game play election options was accepted.

23. The method of claim 21, wherein the third game play election is folding when both the first game play election and the second game play election options is checking.

24. The method of claim 21, wherein resolving all accepted wagers comprises refunding to the player a greatest play wager of all accepted of the first play wager, the second play wager, and the third play wager for a dealer hand rank exceeded by a predefined minimum qualifying rank.

25. The method of claim 21:
further comprising before dealing the cards to form the dealer hand and dealing the other cards to form the player hand, accepting a side wager from the player; and
wherein resolving all accepted wagers comprises resolving the side wager.

26. The method of claim 25, wherein resolving the side wager is not based on a dealer hand rank.

27. The method of claim 21, wherein:
performing a first card distribution act comprises dealing three cards designated for the player hand and no other hand;
performing at least one intermediate card distribution act comprises dealing two cards designated for the player hand and no other hand; and
performing a final distribution act comprises dealing two other cards designated for the player hand and no other hand.

28. A method of administering a wagering game, comprising:
accepting an ante wager from a player;
dealing a complete hand of cards to form a dealer hand;
dealing cards to form a player hand, comprising performing at least two card distribution acts;
administering a game play election event, comprising:
providing a set of game play election options comprising a play wager option;
accepting from the player an election selected by the player from the set of game play election options;
before performing a last card distribution act of the at least two card distribution acts,
administering at least another game play election event, comprising:
providing another set of game play election options comprising another play wager option, the another set of play wager options being independent of the set of play wager options;
accepting from the player another game play election selected by the player from the another set of game play election options;
after performing the last card distribution act of the at least two card distribution acts,
administering a final game play election event, comprising:
providing a final set of game play election options comprising a final play wager option;
accepting from the player a final game play election selected by the player from the final set of game play election options; and
resolving all accepted wagers.

29. A method of administering a wagering game, comprising:
accepting from a player an ante wager;
accepting from the player a blind wager equal to the ante wager;
dealing seven cards to form a seven-card dealer hand;
dealing three cards for a player hand;
administering a first game play election event, comprising:
providing a first set of game play election options consisting of checking and a first play wager limited to three times the ante wager; and
accepting from the player a first election selected from the first set of game play election options;
dealing two cards for the player hand;
administering a second game play election event, comprising:
providing a second set of game play election options consisting of checking and a second play wager limited to two times the ante wager; and
accepting from the player a second game play election selected from the second set of game play election options;
dealing another two cards to complete a seven-card player hand;
administering a third game play election event, comprising:
providing a third set of game play election options consisting of a third play wager limited to one times the ante wager and one of checking and folding, the one of checking and folding selected for the third set of game play election options based on the first election and the second election; and
accepting from the player a third election selected from the third set of game play election options;
revealing the dealer hand; and
resolving all accepted wagers based at least in part on at least one of a player hand rank of a five-card player hand derived from the seven-card player hand and a dealer hand rank of a five-card dealer hand derived from the seven-card dealer hand.

30. The method of claim 29, wherein resolving all accepted wagers comprises resolving at least two wagers accepted after dealing the seven cards to form the seven-card dealer hand.

31. The method of claim 29, wherein resolving all accepted wagers comprises:
resolving all accepted play wagers of the first play wager, the second play wager, and the third play wager, comprising:
refunding to the player a largest-accepted of the first play wager, the second play wager, and the third play wager for the dealer hand rank exceeded by a predetermined minimum qualifying rank; and
resolving all of the first play wager, the second play wager, and the third play wager not yet refunded based at least in part on the player hand rank and the dealer hand rank.

32. A method of administering a wagering game, comprising:
providing a playing device gaming layout displaying a plurality of wagering areas comprising an ante wager area, a blind wager area, and at least three play wager areas;
accepting from a player an ante wager at least partially covering the ante wager area;
accepting from the player a blind wager at least partially covering the blind wager area;
dealing seven randomly ordered cards to form a dealer hand;
dealing a group of three randomly ordered cards for a player hand;
accepting a first wagering option selected by the player from a first check election and a first play wager election, the first play wager election limited to an amount of a first integer multiple of the ante wager, the first play wager at least partially covering a first play wager area of the at least three play wager areas, the first check election leaving the first play wager area exposed;
dealing two additional randomly ordered cards for the player hand;
accepting a second wagering option selected by the player from a second check election and a second play wager election, the second play wager election limited to an amount of a second integer multiple of the ante wager, the second play wager at least partially covering a second play wager area of the at least three play wager areas, the second check election leaving the second play wager area exposed;
dealing another two additional randomly ordered cards to complete the player hand;
accepting a third wagering option selected by the player from a third play wager election and a one of a fold election and a third check election, the one of the fold election and the third check election provided based at least in part on a state of exposure of the first play wager area and the second play wager area, the third play wager election limited to an amount of a third integer multiple of the ante wager; and
resolving all wagers at least partially covering one of the plurality of wagering areas.

33. The method of claim 32, wherein providing a playing device gaming layout comprises providing the playing device gaming layout supported by an upper surface of a gaming table.

34. The method of claim 29, wherein providing a playing device gaming layout displaying a plurality of wagering areas comprises providing the playing device gaming layout displaying a plurality of wagering areas further comprising a side wager area, the side wager area disposed proximate to a dealer position, the at least three play wager areas disposed proximate to a player position, and the ante wager area and the blind wager area disposed between the side wager area and the at least three play wager areas.

35. A system for administering a wagering game over a computer network, comprising:
An online server-based gaming system configured to be accessed by a user device over a network, the gaming system comprising a processor and associated memory, the processor programmed to:
accept an ante wager instruction from a user device to place an ante wager;
communicate to a user device card values forming a dealer hand;
communicate to a user device card values for a player hand;
accept from a user device a first election from a first set of game play wager options comprising a first play wager option;
communicate to a user device at least one additional card value for the player hand;
accept from a user device a second election from a second set of game play election options comprising a second play wager option;
communicate to a user device at least one final card value for the player hand, the player hand consisting of the card values, the at least one additional card value, and the at least one final card value;
based at least in part on at least one of the first election and the second election, a processor populating a third set of game play election options with a third play wager option and one of a fold election option and a check election option;
accept from a user device a third election from the third set of game play election options; and
resolve all accepted wager instructions.
